(19) United States
(12) Patent Application Publication
(10) Pub. No.: US 2025/0054015 A1
(43) Pub. Date: Feb. 13, 2025

(54) SYSTEMS AND METHODS FOR ITEM-LEVEL ADJUDICATION

(71) Applicant: SKUxchange, LLC, St. Petersburg, FL (US)

(72) Inventors: James Sampey, Indian Rocks Beach, FL (US); Bobby Tinsley, Palmetto, FL (US); Robert Zaccardo, St. Petersburg, FL (US); Kenneth Douglas, Bradenton, FL (US); Moshe Joshua, Woodmere, NY (US); Norberto Maio, St. Petersburg, FL (US)

(21) Appl. No.: 18/929,271

(22) Filed: Oct. 28, 2024

Related U.S. Application Data
(63) Continuation-in-part of application No. 16/784,018, filed on Feb. 6, 2020, now Pat. No. 12,131,331.
Application No. 16/784,018 is a continuation-in-part of application No. 16/503,994, filed on Jul. 5, 2019.
(63) Continuation-in-part of application No. 16/503,999, filed on Jul. 5, 2019.

(51) Int. Cl. G06Q 30/0207; G06Q 30/0238

(52) U.S. Cl. CPC G06Q 30/0225; G06Q 30/0223; G06Q 30/0238

(57) ABSTRACT

Systems and methods for facilitating real-time item-specific application of a gift card balance to a purchase within a collaborative gift card network are described. In some cases, a system for omni-channel item-level promotional offer adjudication is provided, which may include a distributed ledger (in some cases having a plurality of nodes, a transaction log, and a consensus algorithm), a retail system having a payment module, and an adjudication module that enables the retail system to access the distributed ledger. In some cases, the adjudication module is configured to: receive and store item-level information relating to one or more inventory items for which use of a one-time-use coupon code is authorized; receive a purchase request comprising a payment amount and information concerning an item for purchase; receive a one-time-use coupon code; and read the transaction log of the distributed ledger to check whether the one-time-use coupon code has already been redeemed.

### CROSS-REFERENCE TO RELATED APPLICATIONS

This application is a continuation-in-part of prior application Ser. No. 16/784,018, filed Feb. 6, 2020 (titled SYSTEMS AND METHODS FOR COLLABORATIVE GIFT CARD NETWORKS), which itself is a continuation-in-part of prior application Ser. No. 16/503,994, filed Jul. 5, 2019 (titled SYSTEMS AND METHOD FOR MINIMIZING FRAUD IN THE PROMOTIONAL OFFER INDUSTRY), and of prior application Ser. No. 16/503,999, filed Jul. 5, 2019 (titled SYSTEMS AND METHODS FOR FACILITATING SETTLEMENT IN THE PROMOTIONAL OFFER INDUSTRY), each of which is incorporated herein by reference for all it discloses.

### BACKGROUND OF THE INVENTION

### 1. Field of the Invention

The present invention relates to the promotional offer industry, and more particularly to implementing systems and methods for providing increased functionality of item-level adjudication in the promotional offer industry.

### 2. Background and Related Art

In the promotional offer industry, including, without limitation, gift card programs, coupon programs, loyalty programs, and real-time payment programs, there are currently limits and difficulties imposed on participants in the promotional offer industry. For example, using traditional methods, a manufacturer that wishes to issue (e.g., typically through a vendor, marketing agent, etc.) coupons for its products has little or no control over coupon redemption and payment or effects of the couponing program until later (whether thirty days, sixty days, or six months later), when the manufacturer discovers how well the coupon program worked. Even the reward issuer (e.g., the vendor, marketing agent, etc.) typically has little or no control over coupon or offer redemption and payment and little knowledge of the course of redemption. At the same time, there is a significant risk of fraud in the generation of fraudulent coupons, fraudulent reporting of redemption, and the like. Such problems are exacerbated by the convoluted redemption and settlement process. Accordingly, coupon issuers in the promotional offer industry, individually and jointly, traditionally have little knowledge or control over how their promotional coupons are used or if they are effective.

Similar problems are inherent in the gift card industry. Traditionally, there are few to no limits applicable to the use of gift cards. A gift card issuer may wish to limit use of the gift cards toward purchase of certain items, but there is currently no way for gift card issuers to ensure that gift cards are used for any intended purpose. Instead, once a gift card is issued, the recipient is able to use the monetary value of the gift card for any desired purpose, and often (in the case of non-store-specific gift cards) through any desired retailer or location. The gift card value is applied to the total amount of the receipt, regardless of what product or products are purchased, and the gift card is not tied to any specific item or product purchased.

Moreover, current technology of promotional offer redemption systems is limited. For example, point-of-sale (POS) systems often have difficulty integrating with cloud-computing systems (especially where promotional offers are involved), placing limitations on retailers who operate in both physical and online spaces. Moreover, promotional offer redemption is often unavailable or interrupted when connectivity problems arise, or when transactions are delayed due to downtime of third-party payment processor systems or other industry participants.

### BRIEF SUMMARY OF THE INVENTION

Implementations of the systems and methods discussed herein provide safer, more secure, more reliable promotional offer adjudication. In some cases, the promotional offer adjudication is item-specific, omni-channel, and/or immutable.

According to some implementations, an adjudication module for omni-channel item-level promotional offer adjudication is provided. In some cases, the adjudication module includes one or more integrated containers comprising application code, and one or more engines configured to run the container. The container can include any additional elements that make up or help supplement the application code, such as a runtime library, a system library, and a settings configuration. Some implementations of the adjudication module are omni-channel-operative, meaning they are configured to operate in a variety of environments. For example, the adjudication module can be configured to be selectively installed on a retail system which can include one or more of a POS system, a cloud-computing system, or another system comprising a payment module (e.g., capable of accepting payment as part of a purchase transaction).

In some implementations, the adjudication module is configured to do any of the following: receive and store item-level information relating to one or more inventory items for which use of a one-time-use coupon code is authorized; receive a purchase request comprising a payment amount and information concerning an item for purchase; and/or receive the one-time-use coupon code. Subsequently, if the information concerning the item for purchase matches the item-level information for which use of the one-time-use coupon code is authorized, the adjudication module applies the one-time-use coupon code to the purchase request to apply a discount to the payment amount, but if the information concerning the item for purchase does not match the item-level information for which use of the one-time-use coupon code is authorized, the adjudication module does not apply the one-time-use coupon code to the purchase request.

Some implementations are configured such that the engine is configured to run the container separately from and independently of the payment module such that the adjudication module and the payment module do not interfere with one another.

In some cases, the item level information comprises an identifier selected from the group consisting of a stock keeping unit (SKU), a global trade item number (GTIN), a universal product code (UPC), an international article number (ARN), an Australian product number (APN), or a price look-up code (PLU).

In some iterations, the retail system is configured to establish a retailer communicative connection with a bank card processor system. In some cases, the adjudication module is configured to operate without error even if the retailer communicative connection is disrupted. Further, in some cases, the adjudication module is configured to operate on the POS system (or other retail system) without error whether or not the POS system (or other retail system) has internet connectivity.

In some implementations, a distributed ledger (such as a decentralized distributed ledger comprising a plurality of nodes, which can be a public permissionless distributed ledger or any other type of distributed ledger) is utilized to increase the security and reliability of the system. For example, the adjudication module can be configured to utilize a memory storage of the retail system to cause the retail system to operate as a node for the distributed ledger. The distributed ledger can include an immutable transaction log, and the immutable transaction log can include a list of coupon codes such as a one-time-use coupon code. In some cases, each coupon code in the list of coupon codes is accompanied by an indication of whether or not such coupon code has been redeemed. In some cases, the adjudication module applies the one-time-use coupon code to a purchase request, and the retail system updates the immutable transaction log to indicate that the one-time-use coupon code has been redeemed, if the one-time-use coupon code is authorized for such purchase and has not yet been redeemed.

In some cases, the distributed ledger includes a blockchain. In some cases, the distributed ledger includes a transaction log that is immutable (e.g., transactions, once added to the transaction log, cannot be deleted or modified), mutable only by a promotion provider (i.e., only a promotion provider can delete or modify entered transactions), or selectively mutable (mutable only under other specified circumstances). Some implementations of the distributed ledger include a consensus algorithm configured to synchronize the transaction log to ensure that all copies of the transaction log are identical across the plurality of nodes.

In some implementations, the adjudication module is configured to perform additional actions, such as issue additional coupon codes (which, in some cases, can issue directly to a consumer computing device). In some cases, issuance of coupon codes is tracked using the transaction log.

In some implementations, a system for omni-channel item-level promotional offer adjudication is provided. The system can include one or more distributed ledgers (as discussed above). The system can also include any number of retail systems (as discussed above) such as a first retail system (which can include a first payment module and at least one of a first POS system, a first cloud-computing system, and a first retail system of another variety) and a second retail system (which can include a second payment module and at least one of a second POS system, a second cloud-computing system, and a second retail system of another variety). Any additional number of retail systems (e.g., multiple POS systems, multiple cloud-computing systems, multiple websites, multiple retail environments, and/or other types of systems) can be included, giving the system great omni-channel flexibility so that retailers can track and manage sales and promotional offer redemptions across a variety of platforms, locations, and sites.

In some implementations, the system includes one or more adjudication modules (as discussed above). The adjudication module can be installed on each of the first retail system and the second retail system (and any number of additional retail systems), thereby granting the retail systems with functionality as discussed herein (e.g., regarding promotional offer redemption), as well as (in some cases) transforming the retail systems into nodes for the distributed ledger. In some cases, the adjudication module allows the retail systems to access the distributed ledger and read and/or write to the transaction log.

The system of claim 12, wherein each of the first retail system and the second retail system is configured to establish a retailer communicative connection with a bank card processor system, and wherein the adjudication module is configured to operate without error even if the retailer communicative connection is disrupted.

The system has many advantages over current systems. For example, in some implementations it can process promotional offer redemption in non-ideal conditions, such as when internet connectivity is unavailable, or when connectivity with a third-party payment processor is down. In some cases, it also provides secure and fraud-proof redemption, with third-parties being unable to create fake coupons or redeem a coupon more times or for a greater value than is offered, due to the added security of the distributed ledger. In some instances, it also allows for multiple promotional programs to be implemented through a single system simultaneously (such as an HSA program, a retailer-specific program, and/or a store-specific program). For example, the item-level information (e.g., saved in the memory of the retail system or in the transaction log of the distributed ledger) includes a first set of item-level information from a first source and a second set of item-level information from a second source (and any additional numbers of information sets from the same or additional sources). Another advantage is that some implementations are configured to read and deliver to the adjudication module information obtained from a manual entry, information obtained from a scanning of a QR code, information obtained from reading a card, information from a coupon, or any other type of coupon a store could wish to be redeemed. Indeed, some embodiments of the adjudication module are configured to integrate with existing hardware to leverage the existing hardware for coupon redemption. To illustrate, in some cases a POS system equipped with card-reading technology (which is often used to process a credit card or other payment) can be leverages such that the card-reading technology can read a coupon code from a physical card (or from a phone or another source, such as through RFID technology). However, because the adjudication module includes a fully integrated container configured to run separately from any payment module, the installation and running of the adjudication module does not interfere with the native payment processing or other systems of the POS system.

In some cases, implementation of the invention provides systems and methods for facilitating real-time item-specific application of a gift card balance to a purchase within a collaborative gift card network. Implementation of the invention provides methods that permit restriction of gift cards and gift card balances to the purchase of specific items, as well as systems for implementing such methods, such as computer systems and networked computer systems, as well as non-transitory computer-readable media (e.g., software modules) for causing computer systems to implement such methods. Implementation of the invention may be performed using computer systems managed by a single entity as well as in distributed computing environments wherein aspects of the methods are implemented by disparate parties.

According to implementations of the invention, a method is provided for facilitating real-time item-specific application of a gift card balance to a purchase within a collaborative gift card network. The method includes providing a network-connected server that includes one or more communications modules configured to establish one or more communicative connections with external computer systems over one or more computer networks, a long-term memory store, short-term memory, and a processor. The communications module, the long-term memory store, and the short term memory store are operatively connected with the processor to allow the processor to access the communications module, the long-term memory store, and the short-term memory thereby providing the processor with access to data therefrom and transfer of data thereto. The method also includes storing, in the long-term memory store, information relating to one or more items for which use of a gift card is authorized, generating a list of gift card numbers and associated gift card amounts, and storing the gift card numbers and associated gift card amounts in the long-term memory store with an association between each gift card number and its associated gift card amount and information identifying one or more items for which use of the gift card number and its associated gift card amount is authorized. The method further includes steps of establishing a bank card processor communicative connection with a bank card processor computer system, establishing a retailer communicative connection with a retailer computer system, receiving, over the bank card processor communicative connection, an electronic communication comprising a gift card number and information identifying a retailer where the gift card number was provided as at least partial payment for a purchase, and automatically transmitting, over the retailer communicative connection to the retailer computer system, information authorizing the retailer where the gift card number was provided as at least partial payment to apply the gift card amount to the purchase only when the purchase includes the one or more items for which use of the gift card number and its associated gift card amount is authorized.

In some implementations, the method also includes receiving, over the retailer communicative connection from the retailer computer system, an electronic communication including information identifying one or more items included in the purchase. In some implementations, the method includes associating the electronic communication received over the bank card processor communicative connection with the electronic communication received over the retailer communicative connection, retrieving, from the long-term memory store information the information identifying one or more items for which use of the gift card number and its associated gift card amount is authorized, using the processor to identify a match between the information identifying one or more items for which use of the gift card number and its associated gift card amount is authorized and the information identifying one or more items included in the purchase, and generating the information authorizing the retailer to apply the gift card amount to the purchase.

In some implementations, the information identifying one or more items included in the purchase includes information such as a stock keeping unit (SKU), a global trade item number (GTIN), a universal product code (UPC), an international article number (ARN), or an Australian product number (APN). In some implementations, the method further includes transmitting, over the retailer communicative connection, a request to the retailer computer system to provide the information identifying the one or more items included in the purchase. In some implementations, the server selects the retailer computer system based on the information identifying a retailer received over the bank card processor communicative connection.

In some implementations, the method includes using the gift card number and the information identifying a retailer received over the bank card processor communicative connection to retrieve the association between the gift card number and the information identifying one or more items for which use of the gift card number and its associated gift card amount is authorized, and generating the information authorizing the retailer where the gift card number was provided as at least partial payment to apply the gift card amount to the purchase only if the purchase includes one or more items matching the one or more items for which use of the gift card number and its associated gift card amount is authorized. In some implementations, the information authorizing the retailer where the gift card number was provided as at least partial payment to apply the gift card amount to the purchase includes information associated with each item for which use of the gift card number and its associated gift card amount is authorized such as a SKU, a GTIN, a UPC, an ARN, or an APN.

In some implementations, the information identifying a retailer where the gift card number was provided as at least partial payment includes information identifying a point-of-sale (POS) system at which the gift card number was provided. In some implementations, the information identifying a retailer where the gift card number was provided as at least partial payment includes global positioning system (GPS) or other retailer location information.

According to further implementations of the invention, a method for facilitating item-specific application of a gift card balance to a purchase within a collaborative gift card network is provided. The method includes providing a POS system including a processor, an item-entry system adapted to receive information identifying purchased items as parts of sales, a storage system comprising a computer memory operatively coupled to the item-entry system and configured to store the information identifying purchased items, a payment-receipt system adapted to receive information associated with a gift card payment for sales, a payment-redemption communicative connection adapted to be in at least intermittent communicative connection with a payment-authorization network, and a product-verification communicative connection adapted to be in at least intermittent communicative connection with a product-verification network. The method further includes receiving information at the POS system through the item-entry system identifying one or more purchased items as part of a sale, storing the information identifying one or more purchased items in the computer memory, and receiving information at the POS system through the payment-receipt system identifying a uniquely numbered gift card used as at least partial payment for the one or more purchased items. The method also includes transmitting the information identifying the gift card using the payment redemption communicative connection to a payment authorizer, receiving from the payment authorizer over the payment redemption communicative connection an authorization of the gift card for a gift card amount, and receiving over the product verification communicative connection an electronic communication containing information identifying one or more products for which application of at least a portion of the gift card amount is authorized. The method also includes steps of electronically comparing the information identifying the one or more products for which application of at least a portion of the gift card amount is authorized to the information stored in the computer memory identifying the one or more purchased items, and automatically applying at least a portion of the gift card amount to the sale only if the information identifying the one or more products for which application of at least a portion of the gift card amount matches at least some of the information identifying the one or more purchased items.

In some implementations, the method also includes sending, over the product-verification communicative connection, an electronic communication including the information identifying the gift card. In some implementations, the information identifying the gift card includes a unique gift card number. In some implementations, the information identifying one or more purchased items includes information such as a SKU, a GTIN, a UPC, an ARN, or an APN. In some implementations, the information identifying the one or more products for which application of at least a portion of the gift card amount is authorized comprises information such as a SKU, a GTIN, a UPC, an ARN, or an APN.

According to other implementations of the invention, a method for facilitating item-specific application of a gift card balance to a purchase within a collaborative gift card network, is provided. The method includes providing a POS system including a processor, an item-entry system adapted to receive information identifying purchased items as parts of sales, a storage system comprising a computer memory operatively coupled to the item-entry system and configured to store the information identifying purchased items, a payment-receipt system adapted to receive information associated with a gift card payment for sales, a payment-redemption communicative connection adapted to be in at least intermittent communicative connection with a payment-authorization network, and a product-verification communicative connection adapted to be in at least intermittent communicative connection with a product-verification network. The method also includes steps of receiving information at the POS system through the item-entry system identifying one or more purchased items as part of a sale, storing the information identifying one or more purchased items in the computer memory, and receiving information at the POS system through the payment-receipt system identifying a uniquely numbered gift card used as at least partial payment for the one or more purchased items. The method also includes transmitting the information identifying the gift card using the payment-redemption communicative connection to a payment authorizer and receiving from the payment authorizer over the payment redemption communicative connection an authorization of the gift card for a gift card amount. The method also includes transmitting over the product-verification communicative connection an electronic communication containing information identifying the one or more purchased items, receiving over the product-verification communicative connection a confirmation that the one or more purchased items comprises an item authorized for use of the gift card amount, and automatically applying at least a portion of the gift card amount to the sale only if the confirmation that the one or more purchased items comprises an item authorized for use of the gift card amount.

In some implementations, the method further includes sending, over the product-verification communicative connection, an electronic communication including the information identifying the gift card. In some implementations, the information identifying the gift card includes a unique gift card number. In some implementations, the information identifying one or more purchased items includes information such as a SKU, a GTIN, a UPC, an ARN, or an APN. In some implementations, the information identifying the one or more products for which application of at least a portion of the gift card amount is authorized includes information such as a SKU, a GTIN, a UPC, an ARN, or an APN. In some implementations, the method also includes transmitting information identifying the POS system using the payment-redemption communicative connection.

According to some implementations, the adjudication module is provided to facilitate implementations of any of the discussed methods. In some cases, the adjudication module is configured to integrate with (e.g., run on) any of the discussed systems. In some implementations, the adjudication module is configured to interface with at least one of a POS system and a cloud-computing system via an application programming interface (API). Thus, many systems and methods are discussed, and the adjudication module, distributed ledger, and other system elements represent a substantial improvement in the technology for increasing the reliability, security, and functionality of retail systems in the promotional offer industry.

### BRIEF DESCRIPTION OF THE SEVERAL VIEWS OF THE DRAWINGS

The objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIG. 1 shows a representative computer system for use with embodiments of the invention;

FIG. 2 shows a representative networked computer system for use with embodiments of the invention;

FIG. 3 shows one example of a representative environment in which embodiments of the invention may be implemented;

FIG. 4 shows another example of a representative environment in which embodiments of the invention may be implemented;

FIG. 5 shows another example of a representative environment in which embodiments of the invention may be implemented;

FIG. 6 shows a system configured to implement embodiments of the invention;

FIG. 7 shows a flowchart illustrating a protocol that is implemented by some embodiments of the systems and methods described herein; and

FIG. 8 shows an example of an endpoint implementation guide in connection with the implementation of an API, as is used in connection with some embodiments.

### DETAILED DESCRIPTION OF THE INVENTION

A description of embodiments of the present invention will now be given with reference to the Figures. It is expected that the present invention may take many other forms and shapes, hence the following disclosure is intended to be illustrative and not limiting, and the scope of the invention should be determined by reference to the appended claims.

Embodiments of the invention provide systems and methods for facilitating real-time item-specific application of a gift card (or other promotional offer) balance to a purchase within a retail system or collaborative gift card network. Embodiments of the invention provide methods that permit restriction of gift cards and gift card balances to purchase of specific items, as well as systems for implementing such methods, such as computer systems and networked computer systems, as well as non-transitory computer-readable media (e.g., software modules) for causing computer systems to implement such methods. Embodiments of the invention may be performed using computer systems managed by a single entity as well as in distributed computing environments wherein aspects of the methods are implemented by disparate parties.

According to embodiments of the invention, a method is provided for facilitating real-time item-specific application of a gift card balance to a purchase within a collaborative gift card network. The method (in some embodiments) includes providing a network-connected server that includes one or more communications modules configured to establish one or more communicative connections with external computer systems over one or more computer networks, a long-term memory store, short-term memory, and a processor. The communications module, the long-term memory store, and the short-term memory store are operatively connected with the processor to allow the processor to access the communications module, the long-term memory store, and the short-term memory thereby providing the processor with access to data therefrom and transfer of data thereto. In some embodiments, the communications module includes an API for interfacing between the server and one or more clients (such as retail systems) as discussed in more detail below.

Some embodiments of the method include storing, in the long-term memory store, information relating to one or more items for which use of a gift card is authorized, generating a list of gift card numbers and associated gift card amounts, and storing the gift card numbers and associated gift card amounts in the long-term memory store with an association between each gift card number and its associated gift card amount and information identifying one or more items for which use of the gift card number and its associated gift card amount is authorized. In some embodiments (as discussed in more detail below), memory (such as the long-term memory store) is decentralized instead of stored on a single server, such as through use of a distributed ledger.

The method can further include steps of establishing a bank card processor communicative connection with a bank card processor computer system, establishing a retailer communicative connection with a retailer computer system, receiving, over the bank card processor communicative connection, an electronic communication comprising a gift card number and information identifying a retailer where the gift card number was provided as at least partial payment for a purchase, and automatically transmitting, over the retailer communicative connection to the retailer computer system, information authorizing the retailer where the gift card number was provided as at least partial payment to apply the gift card amount to the purchase only when the purchase includes the one or more items for which use of the gift card number and its associated gift card amount is authorized.

In some embodiments, the method also includes receiving, over the retailer communicative connection from the retailer computer system, an electronic communication including information identifying one or more items included in the purchase. In some embodiments, the method includes associating the electronic communication received over the bank card processor communicative connection with the electronic communication received over the retailer communicative connection, retrieving, from the long-term memory store information the information identifying one or more items for which use of the gift card number (or other coupon code) and its associated gift card amount is authorized, using the processor to identify a match between the information identifying one or more items for which use of the gift card number and its associated gift card amount is authorized and the information identifying one or more items included in the purchase, and generating the information authorizing the retailer to apply the gift card amount to the purchase.

In some embodiments, the information identifying one or more items included in the purchase includes information such as a stock keeping unit (SKU), a global trade item number (GTIN), a universal product code (UPC), an international article number (ARN), an Australian product number (APN), or any other type of produce identification code. In some embodiments, the method further includes transmitting, over the retailer communicative connection, a request to the retailer computer system to provide the information identifying the one or more items included in the purchase. In some embodiments, the server selects the retailer computer system based on the information identifying a retailer received over the bank card processor communicative connection.

In some embodiments, the method includes using the gift card number and the information identifying a retailer received over the bank card processor communicative connection to retrieve the association between the gift card number and the information identifying one or more items for which use of the gift card number and its associated gift card amount is authorized, and generating the information authorizing the retailer where the gift card number was provided as at least partial payment to apply the gift card amount to the purchase only if the purchase includes one or more items matching the one or more items for which use of the gift card number and its associated gift card amount is authorized. In some embodiments, the information authorizing the retailer where the gift card number was provided as at least partial payment to apply the gift card amount to the purchase includes information associated with each item for which use of the gift card number and its associated gift card amount is authorized such as a SKU, a GTIN, a UPC, an ARN, or an APN (or another product code).

In some embodiments, the information identifying a retailer where the gift card number was provided as at least partial payment includes information identifying a point-of-sale (POS) system at which the gift card number was provided. In some embodiments, the information identifying a retailer where the gift card number was provided as at least partial payment includes global positioning system (GPS) or other retailer location information.

According to further embodiments of the invention, a method for facilitating item-specific application of a gift card balance to a purchase within a collaborative gift card network is provided. The method includes providing a POS system (or utilizing an existing one, such as by installing an adjudication module thereon). In some cases, the POS system includes one or more of any of the following: a processor, an item-entry system adapted to receive information identifying purchased items as parts of sales, a storage system comprising a computer memory operatively coupled to the item-entry system and configured to store the information identifying purchased items, a payment module (which may further include a payment-receipt system configured to accept payment, and which may be adapted to receive information associated with a gift card or other promotional offer payment), a payment-redemption communicative connection adapted to be in at least intermittent communicative connection with a payment-authorization network (e.g., for communications with a third-party payment processor), and a product-verification communicative connection adapted to be in at least intermittent communicative connection with a product-verification network.

Some embodiments of the method further include one or more of: receiving information at the POS system through the item-entry system identifying one or more purchased items as part of a sale, storing the information identifying one or more purchased items in the computer memory, and receiving information at the POS system through the payment-receipt system identifying a uniquely numbered gift card used as at least partial payment for the one or more purchased items. The method can also include transmitting the information identifying the gift card using the payment redemption communicative connection to a payment authorizer, receiving from the payment authorizer over the payment redemption communicative connection an authorization of the gift card for a gift card amount, and receiving (e.g., over the product verification communicative connection) an electronic communication containing information identifying one or more products for which application of at least a portion of the gift card amount is authorized. The method can also include steps of electronically comparing the information identifying the one or more products for which application of at least a portion of the gift card amount is authorized to other information, such as the information stored in the computer memory identifying the one or more purchased items (or to information contained in a transaction log of a distributed ledger, as discussed in more detail below), and automatically applying at least a portion of the gift card amount to the sale only if the information identifying the one or more products for which application of at least a portion of the gift card amount matches at least some of the information identifying the one or more items for purchase. If the information does not match, the retail system can be configured to automatically refuse to decrease a purchase amount (or otherwise apply a discount), requiring instead that the customer pay the full stated amount without the discount.

In some embodiments, the method also includes sending, over the product-verification communicative connection, an electronic communication including the information identifying the gift card. In some embodiments, the information identifying the gift card includes a unique gift card number. In some embodiments, the information identifying one or more purchased items includes information such as a SKU, a GTIN, a UPC, an ARN, or an APN. In some embodiments, the information identifying the one or more products for which application of at least a portion of the gift card amount is authorized comprises information such as a SKU, a GTIN, a UPC, an ARN, or an APN.

According to other embodiments of the invention, a method for facilitating item-specific application of a gift card balance to a purchase within a collaborative gift card network, is provided. The method includes (in some embodiments) providing a POS system including a processor, an item-entry system adapted to receive information identifying purchased items as parts of sales, a storage system comprising a computer memory operatively coupled to the item-entry system and configured to store the information identifying purchased items, a payment-receipt system adapted to receive information associated with a gift card payment for sales, a payment-redemption communicative connection adapted to be in at least intermittent communicative connection with a payment-authorization network, and a product-verification communicative connection adapted to be in at least intermittent communicative connection with a product-verification network. The method also includes (in some cases) steps of receiving information at the POS system through the item-entry system identifying one or more purchased items as part of a sale, storing the information identifying one or more purchased items in the computer memory, and receiving information at the POS system through the payment-receipt system identifying a uniquely numbered gift card used as at least partial payment for the one or more purchased items. The method also includes (in some cases) transmitting the information identifying the gift card using the payment-redemption communicative connection to a payment authorizer and receiving from the payment authorizer over the payment redemption communicative connection an authorization of the gift card for a gift card amount. The method also includes transmitting over the product-verification communicative connection an electronic communication containing information identifying the one or more purchased items, receiving over the product-verification communicative connection a confirmation that the one or more purchased items comprises an item authorized for use of the gift card amount, and automatically applying at least a portion of the gift card amount to the sale only if the confirmation that the one or more purchased items comprises an item authorized for use of the gift card amount.

In some embodiments, the method further includes sending, over the product-verification communicative connection, an electronic communication including the information identifying the gift card. In some embodiments, the information identifying the gift card includes a unique gift card number. In some embodiments, the information identifying one or more purchased items includes information such as a SKU, a GTIN, a UPC, an ARN, or an APN. In some embodiments, the information identifying the one or more products for which application of at least a portion of the gift card amount is authorized includes information such as a SKU, a GTIN, a UPC, an ARN, or an APN. In some embodiments, the method also includes transmitting information identifying the POS system using the payment-redemption communicative connection.

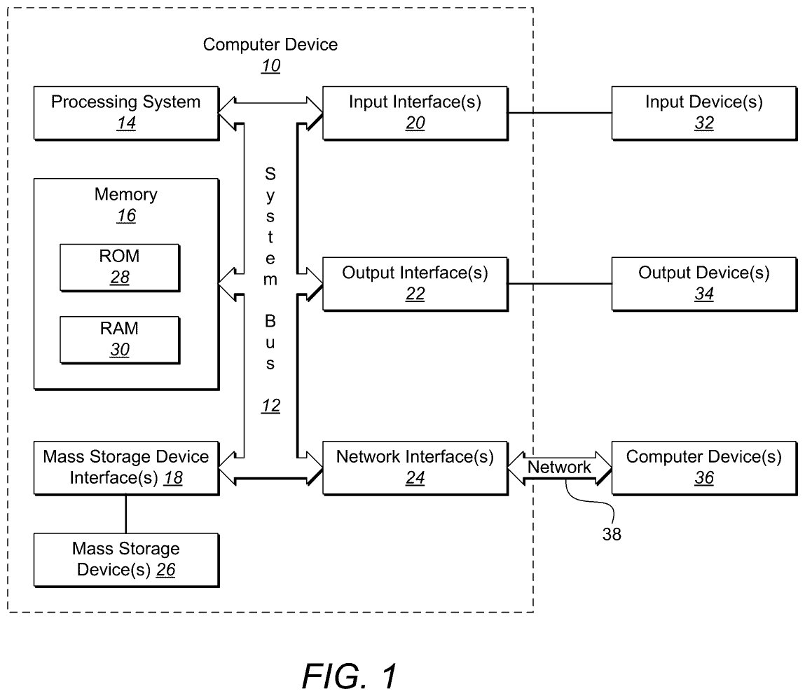

FIG. 1 and the corresponding discussion are intended to provide a general description of a suitable operating environment in which embodiments of the invention may be implemented. One skilled in the art will appreciate that embodiments of the invention may be practiced by one or more computing devices and in a variety of system configurations, including in a networked configuration. However, while the methods and processes of the present invention have proven to be particularly useful in association with a system comprising a general purpose computer, embodiments of the present invention include utilization of the methods and processes in a variety of environments, including embedded systems with general purpose processing units, digital/media signal processors (DSP/MSP), application specific integrated circuits (ASIC), stand-alone electronic devices, and other such electronic environments.

Embodiments of the present invention embrace one or more computer-readable media (by way of non-limiting example, an adjudication module), wherein each medium may be configured to include or includes thereon data or computer executable instructions (e.g., computer code, computer libraries, and system configurations) for manipulating data. The computer executable instructions can include data structures, objects, programs, routines, or other program modules that may be accessed by a processing system. In some embodiments, the computer readable media are specifically configured to improve a retail system (e.g., a cloud-computing retail system, a POS retail system, or another retail system, which otherwise would be subject to many disadvantages such as poor reliability, versatility, or security). For example, some embodiments of the computer readable media enable the retail system to perform additional functions, access or operate as part of a distributed ledger, or otherwise operate in a manner superior to retail systems that lack the computer readable media in question.

Generally speaking, computer executable instructions cause the processing system to perform a particular function or group of functions and are examples of program code means for implementing steps for methods disclosed herein. Furthermore, a particular sequence of the executable instructions provides an example of corresponding acts that may be used to implement such steps.

Computer-readable media may include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), digital versatile disc (“DVD”) media, Blu-Ray media, or any other device or component that is capable of providing data or executable instructions that may be accessed by a processing system. While embodiments of the invention embrace the use of all types of computer-readable media, certain embodiments as recited in the claims may be limited to the use of tangible, non-transitory computer-readable media, and the phrases “tangible computer-readable medium” and “non-transitory computer-readable medium” (or plural variations) used herein are intended to exclude transitory propagating signals per se.

As discussed in more detail below, some embodiments of the systems and methods discussed herein include computer-readable media packaged in a particular manner to enable module versatility and allow for omni-channel operations. For example, in some cases, an adjudication module is included in a container (e.g., a docker container or another type of container) configured to be run by an engine as a stand-alone program, such that it can be installed on and run by a variety of retail systems (e.g., both a POS system and a cloud-computing system) and such that execution of the adjudication module does not interfere with native modules (e.g., a payment module or other native systems).

With reference to FIG. 1, a representative system for implementing embodiments of the invention includes one or more computer devices 10. For example, computer device 10 may be a personal computer, a notebook or laptop computer, a netbook, a personal digital assistant (“PDA”) or other hand-held device, a smart phone, a tablet computer, a workstation, a minicomputer, a mainframe, a supercomputer, a multi-processor system, a network computer, a processor-based consumer electronic device, a computer device integrated into another device or vehicle, or the like. In some embodiments, computer device 10 is or forms part of a point-of-sale (POS) system such as a register, a sales tablet, a sales mobile device such as a smart phone, a payment processing system, or the like. In some embodiments, computer device 10 is or forms part of a server used in a cloud computing environment. Some embodiments require multiple computer devices, such as a POS system, a server, a consumer computing device, and a plurality of nodes, linked together via particular functionality (and in a particular manner) enabled by an adjudication module, as discussed herein.

In some embodiments, computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer-readable media, such as on memory 16, a solid state drive, a removable solid state drive, a magnetic hard disk, a removable magnetic disk, a magnetic cassette, an optical disk, or from a communication connection, which may also be viewed as a computer-readable medium.

Memory 16 includes one or more computer-readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include solid state drives, hard disk drives, magnetic disk drives, tape drives and optical disk drives. A mass storage device 26 may read from and/or write to solid state memory, a magnetic hard disk, a removable magnetic disk, a magnetic cassette, an optical disk, or another computer-readable medium. Mass storage devices 26 and their corresponding computer-readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through hardware, such as one or more corresponding input devices 32. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. When computer device is or is part of a POS system, additional input interface examples include SKU scanning devices, near-field-communication (“NFC”) contactless payment card readers, EMV-standard card readers, magnetic card readers, keypads, NFC product scanners, associated touch screens, and the like. Importantly, the adjudication module (according to some embodiments) is configured to utilize existing hardware of a POS system to provide additional functionality (such as utilizing a card reader originally configured to pass information from a credit card or other payment card to a third-party payment processor to instead read a coupon code or other information for separate processing in accordance with the instructions of the adjudication module).

Similarly, examples of input interfaces 20 that may be used to connect the input devices 32 to the system bus 12 include a serial port, a parallel port, a game port, a universal serial bus (“USB”), an integrated circuit, a firewire (IEEE 1394), or another interface. For example, in some embodiments input interface 20 includes an application specific integrated circuit (ASIC) that is designed for a particular application. In a further embodiment, the ASIC is embedded and connects existing circuit building blocks. In some embodiments, one or more input interfaces 20 may be provided by an external device connected to a port of the system (e.g., as a peripheral device).

One or more output interfaces 22 may be employed to connect one or more corresponding output devices 34 to system bus 12. Examples of output devices include a monitor or display screen, a speaker, a printer, a multi-functional peripheral, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices. For example, in some cases the adjudication module (or implementation of a system containing such) enables the retail system to access a distributed ledger, enabling many of the security and reliability features described herein.

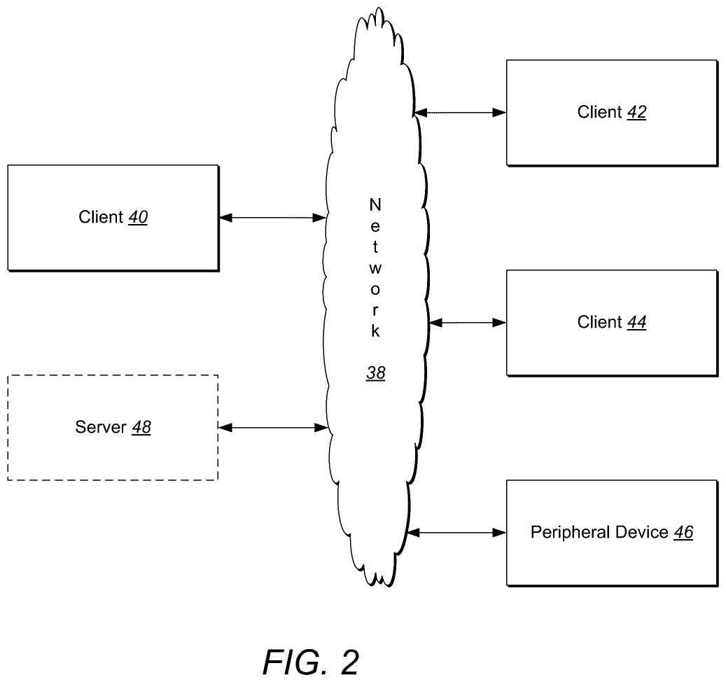

Thus, while those skilled in the art will appreciate that embodiments of the present invention may be practiced in a variety of different environments with various types of system configurations, FIG. 2 provides a representative networked system configuration that may be used in association with embodiments of the present invention. The representative system of FIG. 2 includes a computer device, illustrated as client 40, which is connected to one or more other computer devices (illustrated as client 42 and client 44) and one or more peripheral devices 46 across network 38. While FIG. 2 illustrates an embodiment that includes a client 40, two additional clients, client 42 and client 44, one peripheral device 46, and optionally a server 48, connected to network 38, alternative embodiments include more or fewer clients, more than one peripheral device, no peripheral devices, no server 48, and/or more than one server 48 connected to network 38. Other embodiments of the present invention include local, networked, or peer-to-peer environments where one or more computer devices may be connected to one or more local or remote peripheral devices. Moreover, embodiments in accordance with the present invention also embrace a single electronic consumer device, wireless networked environments, and/or wide area networked environments, such as the Internet.

Similarly, embodiments of the invention embrace cloud-based architectures where one or more computer functions are performed by remote computer systems and devices at the request of a local computer device. Thus, returning to FIG. 2, the client 40 may be a computer device having a limited set of hardware and/or software resources. Because the client 40 is connected to the network 38, it may be able to access hardware and/or software resources provided across the network 38 by other computer devices and resources, such as client 42, client 44, server 48, or any other resources. The client 40 may access these resources through an access program, such as a web browser, and the results of any computer functions or resources may be delivered through the access program to the user of the client 40. In such configurations, the client 40 may be any type of computer device or electronic device discussed above or known to the world of cloud computing, including traditional desktop and laptop computers, smart phones and other smart devices, tablet computers, or any other device able to provide access to remote computing resources through an access program such as a browser.

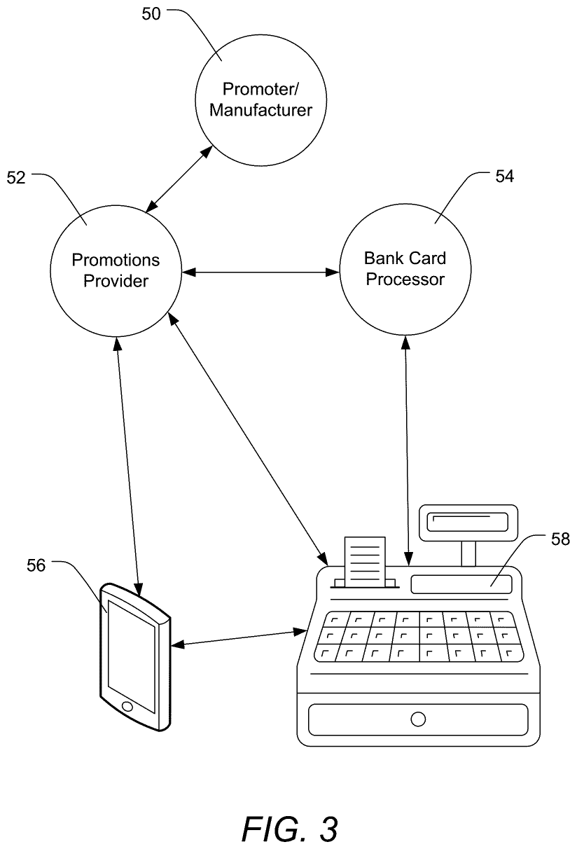

FIG. 3 illustrates one representative environment in which embodiments of the invention for facilitating item-specific application of gift card balances may be implemented. The promotion environment includes a promoter 50, which in some instances is a manufacturer of products or a provider of services, or in other instances is an entity or organization operating on behalf of a manufacturer or other provider. In some circumstances, the promoter 50 may be a retail store or chain electing to offer discounts on the products it carries or services it sells. In other circumstances, the promoter 50 is a third party tasked with representing a retail store or chain. Accordingly, it should be understood that the promoter 50 illustrated in FIG. 50 may be any of a number of entities in the retail, wholesale, and promotions industry and is not intended to be limited to any particular role. Nevertheless, the promoter 50 is the entity that determines to begin a promotional campaign. The promoter 50 determines to generate a promotion on products or services, and engages a promotions provider 52 to operate the promotion on its behalf. In a typical example of a promotion, a promotion campaign will involve generation of a number of coupons representing a discount on the goods or services of the manufacturer/service provider that is either the promoter 50 or is represented by the promoter 50.

Historically and even often today, promotions typically involved printing and distribution of a number of generic or identical coupons in newspapers, magazines, mailers, and the like. The provision of such coupons entitled the bearer thereof to receive a discount (a percentage or set amount off) at any retailers accepting coupons provided by the manufacturer (or issued by an issuer on behalf of the manufacturer). Typically, such coupons are valid for a limited period of time, after which they are no longer accepted at retailers or other locations. The provision of generic or identical paper coupons in this manner leads to certain problems for the parties involved in the promotional offer and redemption process. Often, it can be difficult to estimate a rate at which the promotional offers will be redeemed. Additionally, paper coupons are subject to duplication attempts whereby more coupons may enter the stream of commerce than the promoter 50 originally intended. Accordingly, promoters 50 cannot predict the frequency at which coupons will be redeemed, or do anything to stop a promotion that results in greater redemption than expected, whether due to fraudulent causes or to other innocent causes. As a result, some promotions have resulted in promotion overspending.

Traditional coupons are typically entered into point-of-sale computer systems by the owners of the point of sale, either once near the start of a promotion, or on an ongoing basis as each coupon is received. Some traditional coupons are printed with bar codes or other redemption indicia that facilitates computer-based scanning or other automated entry by the point-of-sale systems, but traditional coupons are typically identical such that they all share an identical bar code or other scanning indicia. Again, such coupons are not at all fraud resistant, and furthermore they lack any mechanism that permits rapid verification of coupon authenticity and redemption in a way that would permit rapid reconciliation and settlement. Additionally, limiting use of the coupons to specific items actually purchased requires either that the retailer enters the coupon into its system and associates it with limited items for sale, or relies on checkout personnel to ensure that associated items were actually purchased.

Accordingly, the retailer is forced to accept a loss on sales until enough time has passed to allow for sending in received coupons, transport of such coupons to an offsite (often out-of-country to take advantage of reduced labor costs) location for verification and counting, auditing, and any other reconciliation processes before the retailer is ever reimbursed for applied discounts. Additionally, if the coupon is entered incorrectly at the point-of-sale systems, it can result in coupons being redeemed for more or less than face value, again leading to problems for the retailer and/or the promoter 50.

Systems and methods in accordance with embodiments of the invention address these and similar concerns. In the representative environment illustrated in FIG. 3, the promoter 50 (which may, in some embodiments, be a manufacturer) enters into a relationship with a promotions provider 52. In at least some embodiments, there is an electronic communicative link established between the promoter 50 and the promotions provider 52, whereby a representative of the promoter 50 is able to access systems operated by the promotions provider 52 and associated with a promotional campaign so as to review associated reports and/or to manage one or more aspects of the promotional campaign. The representative of the promoter 50 may be any person or group of persons tasked with managing the promotion on behalf of the promoter 50. In other embodiments, an electronic communications link is not established between the promoter 50 and the promotions provider 52. In some other embodiments, the promoter 50 and the promotions provider 52 are the same business entity or are divisions within a single business entity.

In the embodiment illustrated in FIG. 3, the promotions provider 52 is tasked with operating or directly managing a promotional campaign on behalf of the promoter 52. The promoter 50 and the promotions provider 52 initially establish the baseline operating conditions for the promotion. By way of example, the initial step may include defining that the promoter 52 wishes to offer a promotional campaign that will result in a total promotions redemption spend of $500,000 (or whatever desired amount), with that redemption spend being allocated to $5 coupons. Accordingly, the anticipated promotional campaign has a target of 100,000 redeemed coupons. In some embodiments, either or both of the promoter 50 or the promotions provider 52 has information from past promotional campaigns that will dictate an approximate number of coupons or other promotional offers that will have to be issued for the promotion to reach the anticipated/desired level of redemption.

To fund the promotional campaign, the promoter 50 transfers an appropriate amount of money (e.g., the $500,000 plus any fees charged by the promotions provider 52) to the promotions provider 52. At that time, the promotions provider 52 internally serializes an appropriate number of coupons or promotional offers (if in a form other than a coupon), whereby each coupon or promotional offer receives its own serial number. Because each coupon or promotional offer is individually serialized, its issuance and redemption can be tracked for a variety of purposes, including permitting rapid reconciliation and settlement as well as tracking use for purchase of allowed items (e.g., filtered to be SKU or other identifier specific).

As discussed in more detail below, the promotions provider 52 in some embodiments adds information about the coupons or promotional offers and their serial numbers to a distributed ledger (e.g., to a blockchain). Accordingly, because the coupons or promotional offers are recorded on the distributed ledger, they are resistant to tampering and can be readily tracked. As coupons and promotional offers are issued (offered to consumers) and then redeemed, their accompanying records on the distributed ledger are updated in some embodiments such that a comprehensive record of the coupons or offers is maintained. In some embodiments, redemption attempts can be checked against the distributed ledger (e.g., a transaction log thereof) before authorizing redemption to prevent fraudulent double redemption attempts, coupon/offer copying, and the like. In some embodiments, an adjudication module enables communication with the distributed ledger, allowing a retail system or another system (e.g., a promoter system) to read and/or write to the distributed ledger as well as to perform its additional functions. In some embodiments, the adjudication module causes the retail system (or other system) to function as a node, thereby adding to the processing power and security of the distributed ledger.

In some embodiments, the serial numbers assigned to the individual coupons or promotional offers are only used internally to the promotions provider 52. The serial numbers operate as an internal tracking mechanism used by the promotions provider in processes such as tracking offers issued and redeemed, and in generating reports. Such reports may include internal reports as well as reports issued to the promoter 50.

In some embodiments, the promotions provider 52 communicates with a bank card processor 54 to facilitate transactions with the coupons or other promotional offers. The bank card processor 54 may be any of a variety of current or future existing payment processors capable of authorizing and processing payments on bank cards (e.g., credit cards). By way of example, the bank card processor 54 may be an entity such as Mastercard Incorporated, capable of processing MasterCard-branded bank cards. Of course, the bank card processor 54 may be any desirable bank card processor or payment processor. In some embodiments, the promotions provider 52 and the bank card processor 54 are the same business entity or are divisions within a single business entity.

In some embodiments, as illustrated in FIG. 3, the promotions provider 52 also communicates with a consumer computing device 56 that is operated by a consumer. Accordingly, an at least intermittent communicative connection is established between one or more computing devices of the promotions provider 52 and the consumer computing device 56. Such communicative connection may be established using existing network infrastructure, including wired and wireless connections, and including use of portions of the Internet, for example. The consumer computing device 56 may be any of a variety of devices in accordance with varying embodiments of the invention. By way of example, the consumer computing device 56 may be a smart phone, a tablet computer, a laptop computer, a desktop computer, a special-purpose computing device such as an application-specific device, and the like.

In some embodiments, a coupon or promotional offer is issued and distributed using traditional means, such as in newpapers, by mail, or by other distribution mechanisms. In such embodiments, however, the coupon or promotional offer is distributed in each individual instance as or with a unique gift card number for each coupon or offer, to ensure that the coupon or offer is resistant to duplication or other fraudulent activity.

In some embodiments, the promotions provider 52, in running the promotion, makes a determination to issue a coupon or promotional offer to the consumer through the consumer computing device 56. This determination may be made in a variety of manners and taking into account a variety of factors. By way of one example, the promotions provider 52 may determine to issue a coupon or promotional offer to the consumer through the consumer computing device 56 based on a geographic location of the consumer computing device 56 (e.g., as determined via a GPS determination or by passage through a geofence as determined by GPS or RFID data). As a specific example of this, a coupon or promotional offer relating to offerings by a local convenience store (e.g., a gasoline promotion, a promotion on fountain drinks, a promotion on snacks, or the like) may be triggered upon passage of the consumer computing device 56 (in this case a mobile device like a smart phone) into a geofenced area surrounding a branch of the convenience store. In some embodiments, upon issuance of a coupon (whether based on geographic location or other factors), the information on which issuance is based is recorded (e.g., to the transaction log of the distributed ledger) to further discourage fraud or abuse of the issuance criteria. As follows, some embodiments include checking the transaction log for matching records prior to issuing a coupon to ensure that a coupon has not already been issued based on the same criteria. Examples of information on which issuance is based can include a serial number of a consumer computing device, an IP address, or other personally-identifiable information. In some embodiments, the adjudication module is configured to facilitate the issuance of coupons (e.g., by monitoring issuance criteria, checking such criteria against the distributed ledger, and issuing coupons only where the issuance criteria are satisfied).

As another example of manners and factors in determining to issue a coupon or promotional offer (i.e., issuance criteria), the consumer may use the consumer computing device to indicate an interest in promotional offers in general or in promotional offers of a particular type. In some embodiments, the consumer uses a program such as a smartphone app or a website that is dedicated to coupons and promotional offers. In other embodiments, the consumer uses a program such as a smartphone app or a website that is dedicated to providing a particular type of service (e.g., a gasoline price/purchase app or website, a supermarket app or website, etc.). Regardless of the app, program, or website used, when the consumer indicates interest in coupons or other promotional offers, the promotions provider 52 makes a determination as to whether the consumer is eligible for any applicable coupons or promotional offers.

When the promotions provider 52 determines that the consumer is eligible to receive a coupon or promotional offer, the system does not necessarily immediately issue the coupon or promotional offer. Instead, in some embodiments, the promotions provider systems initially presents information about the promotional offer to the consumer computing device 56, whereby the consumer is enabled to evaluate the promotional offer and determine whether or not the promotional offer is one the consumer wishes to take advantage of. If so, the consumer can so indicate by way of an action, such as an interaction with a program, app, or website, as is known in the art. As an improvement over prior art treatment of such interactions, some embodiments of the systems and methods herein store a decentralized record of such interactions (e.g., through accessing the distributed ledger). In some cases, this allows multiple retail systems (e.g., systems in various locations) to have access to such interactions and treat them as appropriate. In some embodiments, such as when the consumer has already expressed an interest in promotional offers or coupons, the promotions provider 52 may immediately proceed to issuing a coupon or formal promotional offer.

At the point where the promotions provider 52 determines (manually or automatically) to issue a coupon or promotional offer, one of the serialized promotional offers or coupons is allocated to the promotional offer, and a one-time-use bank card number (e.g., a gift card number, in some embodiments) is assigned to the promotional offer or coupon. For example, where the bank card number is a MasterCard number, the bank card number assigned to the promotional offer or coupon may be a sixteen-digit number. The bank card number acts as a redeemable code for redemption of the offer or coupon. Where information about coupons and/or offers is maintained on a distributed ledger (e.g., on a blockchain and/or transaction log thereof), the bank card number associated with the offer/coupon is recorded to the distributed ledger, potentially along with information associated with the consumer to whom the offer/coupon is to be issued, along with information indicating that the offer/coupon was issued to the consumer. The offer or coupon is then issued to the consumer using the consumer computing device 56. No other consumer receives the same bank card number.

In embodiments where the coupon or promotional offer is to be limited to use with one or more specific products or services, the bank card number associated with the offer/coupon is also associated with one or more products or services for which redemption of the offer/coupon is authorized, and that authorization is also recorded. In some embodiments, the authorized product(s) or service(s) is/are recorded on the blockchain, and in other embodiments, the authorized product(s) or service(s) is/are recorded separately from the blockchain. In some embodiments, the information regarding the authorized products or services includes information associated with each item for which use of the gift card number and its associated gift card amount is authorized such as a SKU, a GTIN, a UPC, an ARN, or an APN.

The consumer may receive and use the coupon or offer in a variety of different ways. In some embodiments, the consumer receives a printable coupon, and may use a printing device (not shown in FIG. 3) to print the coupon for use at a point of sale. The printable coupon includes the bank card number and/or scannable indicia representative of the bank card number to facilitate redemption of the coupon at the point of sale. In other embodiments, the consumer receives an electronic coupon that the consumer is able to redeem at the point of sale by, for example, displaying the electronic coupon on his or her smartphone (e.g., the consumer computing device 56) either for scanning or manual entry of the bank card number at a point-of-sale device. Accordingly, FIG. 3 illustrates that the system of some embodiments includes a point-of-sale device 58 or system that is adapted to receive entry of the bank card number, either from the point-of-sale operator or from the consumer, such as using computing device 56. In some embodiments, the consumer computing device 56 and the point-of-sale device 58 are able to communicate with each other, such as wirelessly (e.g. near-field communication (NFC)). In other embodiments, the consumer receives the bank card number and is able to store it on a consumer magnetic strip adapted to be read by traditional magnetic strip readers at the point-of-sale device 58. In other embodiments, the consumer receives the bank card number as a gift card that is compatible with the EMV-standard chip-and-pin systems and is able to use it with an EMV-standard reader.

When the point-of-sale device 58 receives the bank card number, the point-of-sale device 58 initiates an authorization process with the bank card processor 54. Accordingly, the point-of-sale device 58 is in at least transient or intermittent communicative connection with the bank card processor 54. The bank card processor 54 performs an authorization step to verify that the bank card number is valid and unused, which step may be performed in part by communications with the promotions provider 52 in at least some embodiments. Accordingly, the promotions provider 52 has a communicative connection with the bank card processor 54. The promotions provider 52 can then check the bank card number against its records to ensure that the bank card number is valid and has not been used, and can update its records, including the distributed ledger, to reflect that the coupon or other promotional offer associated with the bank card number has been used and cannot be used again. Assuming the coupon, gift card, or other promotional offer has not yet been used and is otherwise still valid (an applicable promotional period has not expired or passed the expiration date assigned to the bank card number), an authorization is transmitted back to the point-of-sale device 58 by the bank card processor 54.

Embodiments of the invention, however, provide for a further authorization step to ensure that a balance associated with the coupon, gift card, or other promotional offer is only applied to purchase of authorized items. This step occurs between the promotions provider 42 and the retailer, and, in some embodiments, specifically the point-of-sale device 58. Accordingly, the point-of-sale device 58 is in at least transient or intermittent communicative connection with the promotions provider 52 (e.g., with a promotions provider server connected to a communications network). Such communicative connection is provided in various ways according to various embodiments of the invention. In some embodiments, the communicative connection between the point-of-sale device 58 and the promotions provider 52 utilizes a same or similar network as the communicative connection between the point-of-sale device 58 and the bank card processor 54, and may use the same or a similar network interface 24. In other embodiments, the communicative connection between the point-of-sale device 58 and the promotions provider 52 utilizes a different network than the communicative connection between the point-of-sale device 58 and the bank card processor 54, and may use a different network interface 24.

In some embodiments, the communicative connection between the point-of-sale device 58 and the promotions provider 52 is continuous or near-continuous and is used as necessary. In other embodiments, the communicative connection between the point-of-sale device 58 and the promotions provider 52 is intermittent and only established as necessary. In some embodiments, the communicative connection between the point-of-sale device 58 and the promotions provider 52 is a virtual connection, in that the retailer of the point-of-sale device establishes a communicative connection with the promotions provider 52 and obtains its own list of promotions (e.g., gift card numbers or the like) and associated allowable items, after which the point-of-sale system 58 connects to and/or references the previously obtained list maintained by the retailer on its own systems.

In some embodiments, the communicative connection between the point-of-sale device 58 and the promotions provider 52 is established by the point-of-sale device 58. In other embodiments, the communicative connection between the point-of-sale device 58 and the promotions provider 52 is established by a system of the promotions provider 52. Where the communicative connection is established by a system of the promotions provider 52, the promotions provider system obtains information regarding the identity of the point-of-sale device 58 from the bank card processor 54 as part of the authorization process for authorizing the bank card number, and the promotions provider system uses this information to establish communication with the point-of-sale device as part of the secondary authorization step (e.g., by way of an application programming interface (API) call to a system of the point-of-sale device 58). Where the point-of-sale device 58 establishes the communicative connection with the promotions provider system, it may do so based on information already stored by the point-of-sale system 58 or by systems of the retailer that identify when to establish the communicative connection.

Once the communicative connection between the promotions provider 52 and the point-of-sale system 58 is established, the secondary authorization step is performed. In this step, a comparison is performed between the redeemed bank card number (e.g., gift card number), and the information associated with allowed items (e.g., SKU number and the like). In some embodiments, the comparison is performed at the promotions provider 52. In such instances, the point-of-sale device 58 transmits a set of information identifying the one or more items purchased by the consumer to the promotions provider 52 (e.g., SKUs, GTINs, UPCs, ARNs, APNs, or the like). The systems of the promotions provider 52 then compare the purchased items to the items associated with the particular bank card number (e.g., gift card number) attempted to be redeemed as at least partial payment for that particular purchase to see if there is a match. If and only if there is a match, the promotions provider 52 then sends an authorization back to the point-of-sale device 58, whereby application of the balance to the purchase is authorized.

In other embodiments, the comparison is performed at the point-of-sale system 58 (or at another computer system controlled by the retailer). In such embodiments, the promotions provider system uses the bank card number to obtain from its memory stores the associated item or items for which use of the bank card number (e.g., gift card number) is authorized, and then transmits a set of information identifying the one or more authorized items (e.g., SKUs, GTINs, UPCs, ARNs, APNs, or the like) to the point-of-sale system 58. The point-of-sale system 58 then performs a comparison between this information and corresponding information relating to the purchased items stored in its memory stores to determine if a match exists. If and only if there is a match, the point-of-sale device 58 then applies the balance to the purchase. In some embodiments, a notification of application of the gift card balance is then transmitted back to the promotions provider 52, either directly by the point-of-sale device 58 or indirectly by way of a transmission to the bank card processor 54.

Accordingly, per methods such as these, real-time controls can be exerted on the redemption of gift cards and other promotional offers to ensure that promotional offers are item-specific, product-specific, service-specific and the like. Where an issued promotional offer (e.g., associated with a bank card number or gift card number) is attempted to be redeemed for products or services not associated with the offer, the attempt can be declined even if there is a balance remaining associated with the offer. Such declining happens in real time and prevents use of promotional balances for items such as products or services for which the offer was not intended. Furthermore, the systems disclosed herein (e.g., the adjudication module as installed across a variety of retail systems, in connection with the distributed ledger) can ensure that real-time controls can be exerted from multiple locations at once. As an example, if a promotional offer is offered only to the first 100 purchasers, 100 coupons can be issued (and their redemption status tracked from multiple locations simultaneously via the distributed ledger). Thus, a physical retail store in a first location, a physical retail store in a second location, and an online store (each of which has a retail system running a copy of the adjudication module) can all track the redemption status of the coupons simultaneously and stop offering the promotional offer as soon as the 100^{th} coupon has been redeemed in any location. This is not possible using manual coupon systems or retail systems (e.g., POS systems) that are not interconnected. Furthermore, using a distributed ledger, as enabled via the adjudication module, allows the foregoing to be accomplished with an unprecedented level of security and accuracy.

Funds associated with redemption of the coupon or other promotional offer can be allocated as necessary on an ongoing basis. In some embodiments, settlement of necessary funds can occur each day at the end of the day. In other embodiments, settlement of funds occurs less frequently, such as every three to five days or weekly. In other embodiments, settlement of funds can occur in real time. In general, settlement of funds may occur on a time schedule that greatly increases the rapidity with which retailers receive their money, taking into account factors such as money transfer costs associated with many small transfers (e.g., some accumulation may occur to minimize transfer fees). Thus, as may be appreciated, settlement of funds may occur on any desired schedule, taking into account ensuring relatively rapid settlement of funds while avoiding unnecessary transfers of small amounts of money repeatedly. In other words, in some embodiments, settlement of funds may occur no later than the earlier of after a certain amount of time has passed or after a minimum settlement amount is owed to a particular retailer or other person or entity associated with redemption of the coupon or other promotional offer.

In some embodiments, settlement occurs with payment to the retailer or other business or individual at which the coupon or other promotional offer was redeemed. In other embodiments, settlement occurs with payment to an account of the consumer that redeemed the coupon or other promotional offer. Each of these involves a slightly different mechanism or process associated with the bank card number of the coupon.

In some embodiments, when the bank card number is issued to the consumer, a fund amount associated with the coupon or promotional offer is associated with the bank card number. In effect, the consumer receives a bank card (equivalent to a gift card) with a monetary value equal to the coupon or promotional offer value (e.g., three dollars, ten euros, etc.). In such embodiments, the bank card number can be used like any traditional credit or gift card as partial payment for the goods or services associated with the promotional offer or coupon, except that unlike previous credit or gift cards, use of the card is limited to authorized purchases. In such embodiments, accordingly, the retailer receives the bank card number at the point-of-sale device 58, and an authorization request is sent to the bank card processor 54 in the amount of the face value of the coupon or other promotional offer. When the authorization is approved through both parts of the authorization process (both the card number through the bank card processor 54 and the item(s) purchased through the promotions provider 52), the discount is reflected in the total bill to the consumer at the point-of-sale device 58, and the remaining balance can be paid by the consumer using traditional methods. In this case, funds for the amount of the discount are transferred to the retailer associated with the point of sale.

In other embodiments, when the bank card number is issued to the consumer, no funds are directly associated with the coupon or promotional offer. When the bank card number is received at the point-of-sale device 58, the new authorization transaction with the bank card processor 54 is a zero-value authorization transaction, a zero-ping code, or the like. As this authorization is not a traditional authorization requiring the transfer of actual money to the retailer with guarantees by the bank card processor 54, the bank card processor 54 may optionally charge less for processing this authorization transaction, thereby reducing the cost of processing for the promotional campaign. The promotions provider 52 is still notified of the transaction and is still able to determine whether the transaction relates to an issued and unused coupon or other promotional offer, and can still record the transaction (e.g., on the blockchain), but no money is transferred to the retailer. Instead, at most, an “authorized” transmission is returned to the point-of-sale device 58, and the consumer still pays full price at the point of sale. Nevertheless, because a second authorization process occurs, the system is still able to verify and ensure that the promotional offer was used for its intended purpose. Then, when it comes time to settle the coupon or promotional offer value, the value is returned directly to the consumer, typically by crediting a consumer account associated with the consumer and/or an app operating on the consumer computing device 56.

An advantage of either process is that the retailer need not manually or otherwise program coupons and promotional offers into its systems. Instead, if the bank card is associated with a value, redemption of the card can occur by way of a traditional card authorization with the secondary item-specific authorization step, with the bank card processor 54 returning an authorization communication that includes the amount of the partial payment received from the bank card. Similarly, if the bank card is not associated with a value, redemption of the card occurs by way of a zero-value authorization, with the secondary item-specific authorization step and the consumer still pays full value at the point of sale. The consumer then is reimbursed or receives associated funds directly without merchant involvement. Accordingly, the burden on retailers and other merchants accepting coupons and promotional offers is greatly reduced for both the settlement process as well as the process of being able to accept coupons and promotional offers.

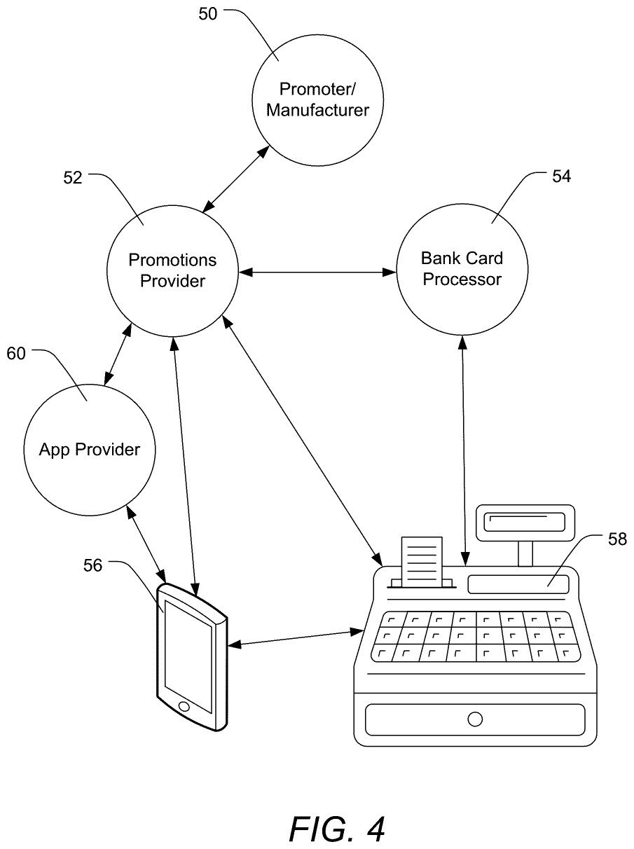

An example of a zero-value authorization environment is illustrated with respect to FIG. 4. This environment is largely similar to the environment of FIG. 3, with the addition of an app provider 60 that provides an app to the consumer computing device 56. In some embodiments, the app provider 60 and the promoter 50 are the same business entity or are divisions of the same business entity. In some embodiments, the app provider 60 and the promotions provider 52 are the same business entity or are divisions of the same business entity. The app provider 60 provides an app that operates on the consumer computing device 56. The app provider 60 may also deliver services to the consumer through the app operating on the consumer computing device 56. By way of example, an app operating on the consumer computing device 56 may provide gas price information to the consumer to facilitate comparison shopping, and may receive and the app provider 60 may deliver updated price information through the app. The consumer may own a consumer account associated with the app, whereby the consumer may receive additional services, discounts, and the like using the app, and may even be able to pay others for goods or services through the app.

In some embodiments, the coupon or other promotional offer is first presented to the consumer through the app provided by the app provider 60. The consumer is also able to accept the offer and receive the coupon or other promotional offer through the app. The consumer may also be able to present the coupon or other promotional offer at the point of sale using the app.

In this environment, when the bank card number is not associated with a value whereby the consumer can partially pay at the point of sale with the bank card number, the system can still provide an equivalent value to the consumer. When the consumer redeems the coupon or other promotional offer at the point-of-sale device 58, the zero-value authorization transaction occurs, and the secondary item-specific authorization occurs, in some embodiments the promotions provider 52 notifies the app provider 60 of the transaction and transfers appropriate funds to the app provider 60. The app provider then credits an account of the consumer on the app with an amount equal to the coupon or other promotional offer. The consumer can then use the funds for goods or services through the app or using the app at other points of sale, if the app provides such functionality. In other embodiments, the app may allow the user to transfer funds from the app to the user's bank account or to other app users.

All this functionality is provided without requiring a direct funds authorization through the bank card processor 54. Instead, because the promotions provider 52 is aware that the coupon or other promotional offer was associated with the bank card number and was issued to the consumer (e.g., upon request of the consumer or upon satisfaction of a geo-location requirement or other precondition), when the promotions provider 52 receives notification of the zero-value authorization request, the promotions provider 52 knows the coupon or other promotional offer was used and can initiate the secondary item-specific authorization process and can then undertake settlement of the value of the offer through any desired process, including nontraditional mechanisms. This settlement process may be immediate or on any appropriate time schedule (e.g., daily, every few days, weekly, etc., as discussed previously).

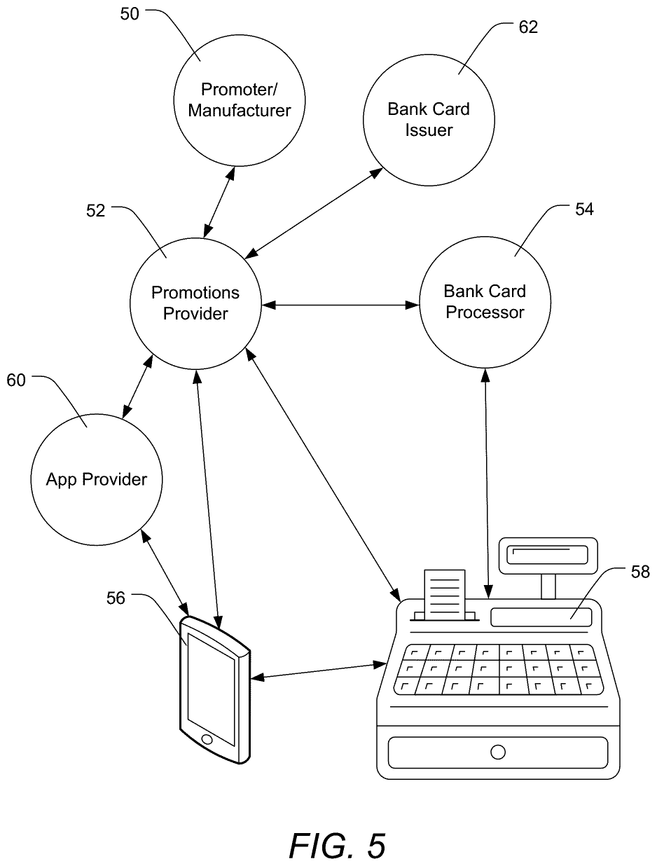

As may be appreciated, embodiments of the invention utilize bank card numbers (or other unique serial numbers) for each coupon or other promotional offer. Accordingly, as illustrated in FIG. 5, certain embodiments of the invention are implemented in a system in which a bank card issuer 62 issues a number of bank card numbers for use in the promotional campaign. As may be appreciated, the obtaining of bank card numbers represents a cost to the promotional campaign. Additionally, the authorization fees charged by the bank card processor 54, whether as zero-value authorizations or authorizations of the face value of the coupon or other promotional offer, are also a cost of the promotional campaign. Accordingly, the promotions provider 52 typically passes such costs on to the promoter 50 when the promotional campaign is initiated. In some instances, lower per-coupon costs may be obtained by way of bulk purchases of bank card numbers and/or by negotiating bulk authorization rates with the bank card processor 54.

Because the use of legitimate bank card numbers in the process represents a cost to the promotional campaign, bank card numbers are typically only associated with coupons or other promotional offers at the time of issuance of a specific coupon or other promotional offer. In embodiments where the coupon or other promotional offer is associated with locational proximity to the location where the coupon or other promotional offer will be used, there is a high likelihood that the coupon or other promotional offer will be redeemed. Nevertheless, a certain amount of non-redeemed offers is to be expected, again representing a cost of the promotional campaign. Nevertheless, embodiments of the invention represent a significant improvement over current coupon promotional campaigns where often a vast number of coupons go unused.

Embodiments of the invention also represent a significant improvement in promoters', issuers', and manufacturers' abilities to monitor and control their promotional campaigns. The secondary item-specific authorization process, in particular, represents a significant improvement in promoters', issuers', and manufacturers' abilities to monitor and control their promotional campaigns. Because coupons and promotional offers can be offered directly to interested consumers and consumers that are in geographic proximity to locations of use, the redemption rate for coupons and other promotional offers is relatively high. Accordingly, fewer overall coupons and promotional offers need be issued, and issuance of coupons and promotional offers can stop at any time, thereby limiting outflow of money relative to the promotional campaign. The promoter 50, issuer, and/or manufacturer will not find itself in a position of underestimating the appeal and/or redemption rate of coupons or promotional offers, such that promoters 50 need not be concerned that promotional campaigns will greatly exceed their allocated budgets.

The promotions provider 52 is also able to provide various reports to the promoter 50 to keep the promoter 50 informed of the status of the promotional campaign. Reports may be provided on a scheduled basis, or the promoter 50 is in some embodiments enabled to access reports on demand to view real-time status of the promotional campaign. The promoter 50 and the promotions provider 52 are thus informed and able to take action if necessary to discontinue or modify the promotional campaign.

Because of the tools and real-time control provided to the promoter 50 by embodiments of the invention, the promoter 50 is able to exercise control over the promotional campaign in ways so as to better achieve campaign goals. By way of example, the promoter 50 may wish, and may have arranged with the promotions provider 52, a promotional campaign that will result in a certain number of promotional redemptions in a certain amount of time. As a specific example, the promoter 50 may intend for a promotion to run for two weeks and may allocate $1 million dollars initially intended to be distributed as 200,000 $5 dollar promotional offers. As the promotional campaign progresses, the promoter 50 may access reports provided by the promotions provider 52 at any time, and may determine that either fewer or more promotional offers are being accepted and redeemed than expected.

If fewer promotional offers are being accepted and redeemed than expected, the promoter 50, possibly consulting with the promotions provider 52, may determine to modify the manner in which the promotions are being offered to consumers or may elect to make the terms of the promotional offer more enticing. As a specific example, if a week of the two-week promotional period has passed and only 10,000 (of the 200,000 anticipated) promotional offers have been accepted, let alone redeemed, the promoter 50 may elect to increase the rate at which or manners by which promotional offers are displayed to consumers for acceptance. Alternately or additionally, the promoter 50 may elect to increase the number of products to which the promotional offer applies. Still alternatively or additionally, the promoter 50 may elect to increase the value of the promotional offer to $6 dollars or some other increased value over the original $5 dollar offering. Any appropriate action may be taken to modify the promotional campaign to achieve campaign goals.

Similarly, if more promotional offers are being accepted and redeemed than initially expected, the promoter 50 may elect to take an action to modify the promotional campaign appropriately. As one example, the promoter 50 may elect to dedicate more funds to the promotional campaign to permit more promotional offers to be extended. Alternatively, the promoter 50 may elect to modify future offered promotions to apply to fewer goods or services, or may even reduce the value of yet-unaccepted or yet-offered promotions to make promotional campaign funds last longer. Such actions can be taken at any time in real time, and can be applied to all offered promotions moving forward.

In some limited circumstances (typically to the benefit of consumers), changes to promotional offers may be made even after acceptance by the consumer but before redemption. For example, a promotion accepted by the consumer may be increased in value after acceptance to encourage redemption. In some embodiments, for example where the promotional offer is provided through an app on the consumer computing device 56, the consumer may be reminded of accepted, but unredeemed, offers from time to time, such as upon a return of the consumer to a local where the promotional offer may be redeemed. Such reminder may include a notification that a value of the promotional offer has increased if such has occurred.

Reminders of accepted promotional offers may serve as another control by which the promoter 50 or promotions provider 52 may seek to modify a redemption rate associated with the promotional campaign. If, for example, an initial reminder rate fails to result in an anticipated or desired level of redemption of promotional offers, the promotions provider 52 may provide an opportunity for the promoter 50 to elect to increase the number of reminders provided to consumers who accepted the promotion. Accordingly, embodiments of the invention provide significant advantages to promoters 50 and to promotional campaigns in the manner in which campaigns can be controlled in real time.

Embodiments of the invention greatly protect against fraudulent activity, essentially eliminating the opportunity for fraud. Additionally, embodiments of the invention greatly improve the settlement process, whereby the recipients of coupons on redemption no longer need participate in a time-consuming manual or pseudo-manual process to receive reimbursement for received coupons. Instead, the prior months-long settlement process is reduced to as little as a day or a few days. In some embodiments, settlement can occur at the time of each transaction (e.g., in real time), essentially eliminating all settlement delay. Because fraud is eliminated using embodiments of the invention, settlement occurs at full coupon value, greatly benefiting honest retailers who often received only 80% or less of coupon value using traditional methods.

The promotions provider 52 maintains a full transaction log of all transactions from creation of the promotional campaign through settlement, including serialization of the coupons or other promotional offers, assigning of the bank card numbers on issuance of the coupons or other promotional offers, redemption thereof, and settlement for redeemed offers. In some embodiments, this information is maintained on the blockchain to prevent data tampering. Accordingly, the promotions provider 52 and the promoter 50 are able to fully able to audit the promotional campaign and verify return on investment at any point in the process, representing a significant improvement over prior methods.

Additionally, methods in accordance with embodiments of the invention provide significantly more information to promoters 50 about the effectiveness of their promotional campaigns. Embodiments of the invention allow the promotions provider 52 to track far more information than merely the number of redeemed offers at the end of a promotional campaign. Instead, the promotions provider 52 can track the rate at which offers are accepted by consumers compared to the rate offers were shown to consumers. The promotions provider 52 can also track the rate at which offers are redeemed as opposed to the rate at which offers were accepted by consumers. The promotions provider 52 can also track down to item-specific redemptions, including where promotional offers applied to more than one item. Furthermore, more granular data can be obtained, such as by way of comparison of offer acceptance and redemption rates in certain locations, with certain timing, and the like. Promoters 50, issuers, and manufacturers can accordingly be much better informed as to the effectiveness of their promotional campaigns.

The systems and methods provided herein allow for multiple different types of promotional offer programs, and multiple programs (of the same or different types), to be created and carried out. Generally, each program is uniquely identified, and each program maintains its own list of items towards adjudication filtering against a transaction's shopping basket (at transaction time). Each item list (per program) is managed separately per retailer (or per promotions provider or other participant in the program). In some cases, item lists at separate retailers will maintain different data elements, but represent the same list of items. Further, each program can contain a protocol-enum that defines how the output amount is to be calculated (e.g., how discounts are to be applied). The amount calculation can be performed by an adjudication module, as discussed below.

In some embodiments, the promotional offer programs used with the disclosed systems and methods include incentive programs. Incentive programs differentiate from payment programs in that they do not settle funds to the retailer at transaction time. Rather, each incentive based program will require a post-transaction settlement mechanism to the retailer. Such programs can be initiated during a POS system's “item entry” phase, before the “tender entry” phase has begun. Incentive programs are often initiated using a barcode or a QR code. In some embodiments, the programs include payment programs, which do settle funds to the retailer at transaction time (e.g., via the existing payment gateway as a normal tender once the adjudication process completes). Payment programs are typically initiated during the “tender entry” phase, after the “item entry” phase has ended. They may be initiated via a scan, a card read (dip, tap, swipe, etc.), or other payment mechanism. Regardless of the promotion type, the result of redeeming a coupon or other promotional offer is generally to provide some reward to the customer, whether in the form of a discount, a rebate, or otherwise. Thus, the term “apply a discount” or a similar term will be used to describe any such application of a promotional offer.

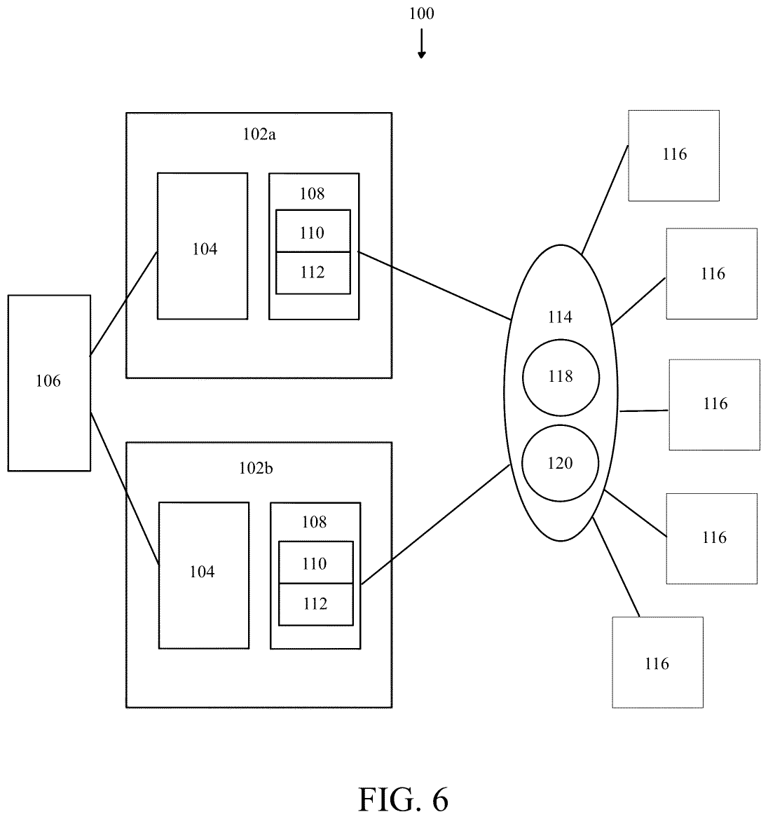

With reference now to FIG. 6, according to some embodiments, any or all of the foregoing systems and/or methods are implemented in a specific environment. In particular, in some embodiments, a system for omni-channel item-level promotional offer adjudication 100 is provided, which can be configured for accomplishing any of the processes or methods, or for providing or improving any of the systems or devices, disclosed herein. Such a system 100 provides safer, more secure, more reliable, more versatile promotional offer adjudication.

Regarding the ability for the system 100 to provide item-specific or item-level adjudication, many federal, state, local, and business-level programs provide discounts or subsidies for purchase of only specific items. For example, “healthy benefits” programs, HAS/FSA, Medicare Advantage, WIC, and other nascent programs (such as employer-funded wellness programs) often apply only to purchase of healthy foods or other eligible items. One distinct advantage of the systems described herein is that they can apply to multiple such programs simultaneously. They eliminate the need for manual item-level verification or for individual initialization of retail systems to automatically apply item-level verification, thereby saving time in either case. Moreover, retailers can sometimes be held responsible for any errors made or fraudulent redemptions, and these additional costs can be prevented through implementation of the system 100.

Furthermore, the programs discussed above often have strict reporting requirements. Retailers are often required to keep detailed records of all item redemptions and meet other strict reporting standards. In some implementations, the system 100 supports the passing of associated basket data in real-time or post transaction to third parties when desired by the merchant or required for auditability of the transaction. Thus, the adjudication module enables reporting to be completed automatically, and to be viewed and verified, in real time, by promotion providers. Moreover, logging transaction data on a distributed ledger (such as a blockchain), as enabled via the adjudication module, can enable a retailer to far more rapidly and easily satisfy federal reporting requirements (or other promotional provider reporting requirements).

Regarding the omni-channel nature of the system 100, many systems (particularly in the promotional offer industry) are configured to apply only to a particular retail system (e.g., a website or a POS system). In contrast, the system 100 is versatilely configured to apply to a wide variety of retail systems 102, either individually or together (e.g., simultaneously). For example, FIG. 6 shows a first retail system 102a and a second retail system 102b as part of the system for omni-channel item-level promotional offer adjudication 100. Any number of additional retail systems 102 can be included. Further, the retail systems 102 can include any type of retail systems 102, including a POS system (which can include a point-of-sale device 58 as discussed herein), a cloud-computing system, or another system configured to process purchasing transactions. In some cases, the retail system includes one or more payment modules 104, which can be any software program (e.g., computer readable media) configured to process a payment in connection with a transaction. In some cases, the payment module 104 is configured to connect the retail system 102 with (e.g., establish a communicative connection with) a payment processor 106 (e.g., a bank card processor 54, a bank, a credit union, a different financial institution, or another type of payment processor). In some cases, the payment module 104 is integral with (e.g., deeply integrated with) the retail system 102. Thus, in some cases, the retail system 102 would not function properly without the payment module 104.

According to some embodiments, the system for omni-channel item-level promotional offer adjudication includes one or more adjudication modules 108. The adjudication module is configured to enable any or all of the functionality described herein. The adjudication module 108 thus represents a substantial improvement to many retail systems 102, as it enables functionality that such retail systems 102 are not capable of performing absent the adjudication module. Furthermore, the adjudication module has many advantages over other modules that could be created which enable some of the functionality discussed herein, but which lack the particular configuration of the adjudication module as discussed below.

In some embodiments, the adjudication module includes one or more containers 110 comprising application code. Generally speaking, the container is a unit of software that packages application code in a way that allows it to run quickly and reliably from one computing environment to another. In other words, it is a standalone executable package of software, which includes everything needed to run the code (including all necessary libraries, dependencies, and configurations). In some cases, the container includes one or more runtime libraries, system libraries, language libraries, dependencies, settings configurations, or other software modalities required for functionality of the adjudication module 108. Some embodiments of the container are omni-channel-operative, meaning they are configured to operate in a variety of environments (e.g., in a cloud-computing environment, on a point-of-sale device, on a consumer computing device, or in another computing environment). In some cases, the container 110 is configured to run on a variety of operating systems (e.g., Windows, Linux, iOS, or other operating systems), which gives it much more versatility as an omni-channel operator. Thus, the container 110 (in some cases) enables forming a unified promotional offer system (with the adjudication module as a common element) across a wide range of diverse platforms. In some cases, the adjudication module 108 is configured such (e.g., due to the container-based structure of the adjudication module 108) that the implementation of the adjudication module 108 is the same for each retail system 102.

In some embodiments, the container includes an engine configured to run the container. In some cases, the engine is configured to enable the native operating system to run the container (e.g., the container may share the retail system's operating system kernel), and in some cases, the engine contains self-sufficient operating system capabilities, thereby allowing the container to be universally portable.

In some embodiments, the container 110 is configured to run (or the engine 112 is configured to run the container 110) separately from and independently of the payment module 104 such that the adjudication module 108 and the payment module 104 do not interfere with one another. In some cases, the container 110 is not deeply integrated with the retail system 102, and the payment module 104 is unaffected by installation or execution of the adjudication module 108. In some embodiments, the container-based nature of the adjudication module 108 also enables rapid installation of the adjudication module 108 on a retail system 102. In some cases, installation takes less than 25 hours, less than 10 hours, less than 5 hours, or any other time less than 25 hours (regardless of the retail system or operating system used). The adjudication module is also easy to update and maintain (e.g., it can be updated without updating the entire POS system or other retail system 102).

In some embodiments, the adjudication module 108 is configured to do any of the following: implement global updates (e.g., rapid updates and changes across all lists and associated programs and across all platforms with which the adjudication module 108 is associated); support embedded promotions within programs (as an example, a buy-one-get-one-half-off promotion within an HSA program); allow for local list management, such as by allowing a promotions manager or a retailer to adjust the promotion on a local level, without any impact from external downtime; allow for a promotion to be updated by inputting the updates only (without a need to provide a complete updated list); support both in-store and online purchases (e.g., for a single promotions program, with shared parameters, simultaneously); be accessed through, or allow access to, other modules via one or more APIs; and substantially decrease the potential for fraud or misuse of funds through leveraging sophisticated reporting and tracking through use of a distributed ledger 114 (e.g., with a blockchain and zero proofs technology, as discussed below).

Regarding more specific implementation of a promotion, the adjudication module 108 of some embodiments is configured to carry out any of the promotional offer operations discussed herein, such as: receiving and storing item-level information relating to one or more inventory items for which use of a one-time-use coupon code is authorized; receiving a purchase request comprising a payment amount and information concerning an item for purchase; and/or receiving the one-time-use coupon code. As an example of carrying out promotional operations, some embodiments of the adjudication module 108 ensure that if the information concerning the item for purchase matches the item-level information for which use of the one-time-use coupon code is authorized, the adjudication module 108 applies the one-time-use coupon code to the purchase request to apply a discount to the payment amount, but if the information concerning the item for purchase does not match the item-level information for which use of the one-time-use coupon code is authorized, the adjudication module does not apply the one-time-use coupon code to the purchase request. Note that the term “apply a discount” as used herein is a broad term that can include any method of providing a benefit in accordance with a promotional offer, including providing an item for free, providing a rebate to a customer, crediting the customer with funds toward a payment, providing incentives, or otherwise implementing a benefit of a promotion (e.g., as discussed above).

In some embodiments, the system for omni-channel item-level promotional offer adjudication 100 includes a distributed ledger 114. The distributed ledger 114 vastly increases the security, reliability, and versatility of the system 100. The distributed ledger 114 comprises a plurality of decentralized nodes 116 that each share a common corpus of information that makes up the distributed ledger 114. The distributed ledger 114 also comprises a consensus algorithm 118 that ensures the distributed ledger is identical across nodes 116. In this regard, the consensus algorithm can by any type of consensus algorithm, but in some cases it is a voting-based consensus algorithm or an economy-based consensus algorithm. In some cases, the consensus algorithm constantly compares the distributed ledger across all nodes and updates the distributed ledger where necessary to remove discrepancies.

In some embodiments, the distributed ledger includes a transaction log 120. The transaction log can include any information relating to the promotional offer, including information designating, assigning a value to, tracking, or otherwise relating to: eligible inventory items; promotional offers; issuance of coupons; redemption of coupons; other aspects of coupons; bank numbers; payments; customers; customer computing devices; location data (e.g., relating to geofencing, etc.); or other aspects of the promotional program.

In some embodiments, the adjudication module 108 enables the retail system 102 to access the distributed ledger 114, therefore enabling all of the security, reliability, versatility, reporting, and other functionality made possible through use of the distributed ledger 114. Thus, any reading, writing, transmitting, receiving of information as discussed herein can go through the transaction log 120 of the distributed ledger 114 (as enabled via the adjudication module 108) for a substantial improvement over systems lacking the adjudication module 108.

In some embodiments, any of the persons or entities described herein (e.g., a promoter, manufacturer, promotions provider, payment processor, app provider, user, government entity, retailer, or otherwise) can be provided with access to all or part of the transaction log (e.g., through the adjudication module 108 or a variant thereof). Thus, the record-keeping and security capabilities of the distributed ledger 114 can be used to satisfy reporting requirements, audit requirements, and other requirements of participating entities.

The distributed ledger 114 can be any type of distributed ledger, including permissioned (only those with permission can view or access), public (anyone can view or access), private (controlled by a central authority with limited access), or otherwise. In some embodiments, the distributed ledger 114 (or any portion thereof, such as the transaction log 120) is immutable, meaning that the records thereof are permanent and cannot be changed, thereby providing a fraud-proof and tamper-proof mechanism of chronicling all relevant transactions (note that the distributed ledger technology enables immutable record keeping, as a centralized record can easily be changed by changing the information at the source where it is stored, whereas tampering with information stored on a single node would not affect the overall distributed ledger 114, because the consensus algorithm 118 would not allow the change). Thus, in some cases, additional information can be added to the transaction log 120 (e.g., the issuance or redemption of a coupon), but once that information is added and made of record on the distributed ledger 114, it cannot be changed (e.g., a coupon cannot be switched from “redeemed” status to “unredeemed”) as this would require updating all nodes simultaneously (which is not technologically feasible, as there can be dozens to hundreds of thousands of nodes in a distributed ledger system).

In some embodiments, the distributed ledger 114 (or any portion thereof) is selectively mutable (or has controlled mutability), meaning that the records can be changed only if established procedures are followed (for example, certain data may be modified only by the promotions provider or another designated participant). In this regard, free mutability or complete immutability can, in some cases, have downsides. Some distributed ledgers with controlled mutability allow records to be changed but place heavy restrictions upon that pathway. Accordingly, no malicious participant or group of participants can alter the records without everyone knowing, but it is still possible for the distributed ledger to adapt to bugs or changing regulations.

In some embodiments, the adjudication module 108 causes the retail system 102 to itself become a node 116 of the distributed ledger 114. The node can be a read-only node, a write-only node, a node with both read and write access, a storage node (with no read or write access), or another type of node. Thus, the adjudication module 108 can transform the retail system 102 into a part of the distributed ledger 114 (without interfering with the native functionality of the retail system 102). In some cases, this not only gives the retail system 102 expanded functionality, but it can also further increase the security and power of the distributed ledger 114 itself (by increasing the number of participating nodes). In some cases, this is done by utilizing a memory storage of the retail system 102 (or of the container 110 of the adjudication module 108) to cause the retail system to operate as a node for the distributed ledger.

In some embodiments, the ability of the adjudication module 108 to cause the retail system 102 to become a node 116 or otherwise interface with the distributed ledger 114 allows the adjudication module 108 to perform local adjudication without the need to send basket items outside the retail system's environment (e.g., item checking can be performed entirely within the retail system's technical environment). Thus, the system can operate even when outside connectivity is disrupted, intermittent, or lagging.

In some cases, the distributed ledger 114 is or otherwise includes a blockchain. Where this is the case, any or all information stored on the distributed ledger can be stored in “blocks” with each block being cryptographically linked the previous block, thereby adding additional security features. Additional encryption and security measures can also be implemented.

The system 100 has many advantages over current systems. For example, in some embodiments it can process promotional offer redemption in non-ideal conditions, such as when internet connectivity is unavailable, or when connectivity with a third-party payment processor is down. In some cases, it also provides secure and fraud-proof redemption, with third-parties being unable to create fake coupons or redeem a coupon more times or for a greater value than is offered, due to the added security of the distributed ledger 114. In some instances, it also allows for multiple promotional programs to be implemented through a single system simultaneously (such as an HSA program, a retailer-specific program, and/or a store-specific program). For example, the item-level information (e.g., saved in the memory of the retail system or in the transaction log of the distributed ledger) includes a first set of item-level information from a first source and a second set of item-level information from a second source (and any additional numbers of information sets from the same or additional sources).

Another advantage is that some implementations are configured to read and deliver to the adjudication module 108 information obtained from a manual entry, information obtained from a scanning of a QR code, information obtained from reading a card, information from a coupon, or any other type of coupon a store could wish to be redeemed. Indeed, some embodiments of the adjudication module 108 are configured to integrate with existing hardware to leverage the existing hardware for coupon redemption. To illustrate, in some cases a POS system equipped with card-reading technology (which is often used to process a credit card or other payment) can be leveraged such that the card-reading technology can read a coupon code from a physical card (or from a phone or another source, such as through RFID technology). However, because the adjudication module 108 includes a fully integrated container 110 configured to run separately from any payment module 104, the installation and running of the adjudication module 108 does not interfere with the native payment processing or other systems of the POS system.

In some embodiments, the system 100 includes a self-service portal module (which can be implemented on a retail system 102 or another computing device). In some cases, the self-service portal module enables rapid creation of promotional offer programs (e.g., healthy benefit programs, coupons, or other such programs), maintenance of lists, and the ability to modify and update programs easily and transparently, including the ability to quickly add items that frequently require additional time to update. Additionally, new capabilities can readily be added to the self-service portal module to support evolving market needs.

Notably, some embodiments of the system 100 include an API for a retail system 102 to interface with the adjudication module 108. In some cases, the API provided instead of the container 110, such that the main code for the adjudication module is run remotely (instead of on the retail system), with the retail system interfacing with the adjudication module 108 via a communicative connection and programmatically interacting with the adjudication module 108 via instructions in the API. In such cases, the adjudication module 108 can still impart any of the functionality to the retail system 102 as discussed herein. In short, some embodiments of the adjudication module may be provided as a hosted service (e.g., an authenticated restful service) instead of a containerized local solution. In some cases, a first retail system 102a utilizes the containerized version, while a second retail system 102b utilizes the hosted version-thus, there is further flexibility relating to the specific implementation of the adjudication module 108.

In some cases, using the containerized version of the adjudication module 108 may have some advantages. As an example, in some cases, by utilizing the container 110, the engine 112 that provides the adjudication is run locally within the retailer's network, per aisle, per transaction; the shopping-basket data never leaves the retail system 120; and the data does not need to be shared unless required for compliance reporting (which can easily be done via the distributed ledger 114, if desired). The resulting output (as a payment) provides all the information that is required towards a traditional tendered transaction (with the main difference being that the “adjudicated-basket-amount” is not being tendered to the payment gateway, instead of the traditional flow for the “total-basket-amount.”

Many advantages of the adjudication module 108 are present regardless of whether a container-based implementation or an API-based implementation is used. For example, in either case, the adjudication module 108 can run without bogging down the memory of the retail system 102. In some cases, the retail system does not necessarily operate as a node 116, but rather has access to the distributed ledger 114 thanks to the adjudication module 108 (in some cases, the adjudication module 108 operates as a node 116, and the retail system interfaces with the adjudication module 108 via container 110 or API). Thus, potentially millions (or more) of unique numbers and transactions can be rapidly tracked by the retail system 102 interfacing with the adjudication module 108, but the retail system 102 itself is not bogged down by the millions of transactions.

In some embodiments, the adjudication module 108 includes a decoder configured to unpack a scanned QR code (or other promotional offer input), or the associated BIN-program, and to run a matching algorithm against one or more items for purchase (e.g., basket items). In some cases, the adjudication module 108 is configured to send a modified payment authorization request (e.g., after a payment amount has been decreased) through the retail system's 102 existing payment processing channel (e.g., the payment module 104).

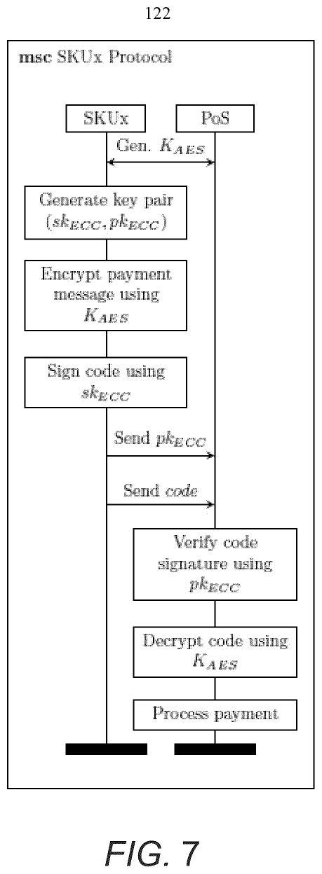

With reference additionally to FIG. 7, some embodiments of the system 100 are configured to implement a security protocol 122. The protocol 122 can be implemented via the adjudication module 108 or a separate security module. The module implementing the protocol 122 (e.g., the security module) can be hosted locally (e.g., on a retail system 102), on a centralized server, or in a decentralized manner (e.g., using the distributed ledger).

In some embodiments, the protocol 122 is configured to create one or more codes, which each code being a machine-read encrypted message that can be used to pay (fully or partially, or to decrease a payment amount or otherwise apply a discount) at an authorized retail system 102 (e.g., at a retailer's point-of-sale). The codes are configured to encrypt payment messages, thereby ensuring that payments can be processed only by authorized points of payment and that the code used to communicate cannot be changed by any party after its secure generation. The protocol 122 results in the generation of immutable (cannot be changed) and private (cannot be read by any unauthorize party) codes. In some cases, the code includes a signature, meaning a part of the code that any entity can use to verify that the code was created by the protocol 122 (or by the entity using the protocol). In some embodiments, the protocol 122 involves encrypting, sending, or receiving one or more messages, meaning encrypted messages that can be decrypted only by those in possession of the designated key.

In some embodiments, the protocol 122 involves one or more of the following: an asymmetric key pair (including a secret key, designated as sk_{ECC}, and a public key, designated as pk_{ECC}); a symmetric key (designated as K_{AES}); advanced encryption standard (designated as AES); elliptic curve cryptography (designated as ECC); a party implementing the protocol 122 (e.g., a promotions provider, a solution providers, etc.—designated as SKUx); and a retail system 102 benefitting from the protocol (designated as PoS, although non-POS-systems are also compatible with the protocol).

The protocol 122 involves two main parts, including: (a) and authentication signature, to ensure that the code cannot be altered in any way, and (b) an encryption, to keep the payment message itself safe, so it cannot be used outside the system in question (e.g., the retail system).

As shown in FIG. 7, in the authentication step, an asymmetric key pair is generated by SKUx via ECC. The asymmetric key pair includes an authentication private key (sk_{ECC}) used to sign the code—which is held by SKUx alone, ensuring that a code cannot be produced by an adversary and allowing the system high security (as there is no need for PoS or other various vendors to hold or access this key)—and an authentication public key (pk_{ECC}) which is publicly available (as it is used to check the signature and verify that the message is authentic and was not chagned). In the encryption step, a symmetric key (K_{AES}) is generated using AES (by either or both of SKUx and PoS), which key is shared between SKUx and PoS (e.g., each retail system will have the ability to decrypt any message encrypted according to the protocol 122). Using K_{AES} the payment can be encrypted by SKUx and decrypted by PoS. A party that does not have K_{AES} will be unable to read the payment in the message, and thus will be unable to use it maliciously.

In accordance with the foregoing and FIG. 7, some embodiments include a method of implementing a security protocol, and the method can include generating or receiving K_{AES} (which can be generated together by both SKUx and PoS). The method can further include any of the following (typically performed by SKUx): generating an asymmetric key pair sk_{ECC} and pk_{ECC} (e.g., by running a “generate key pair” function); encrypting a payment using K_{AES} (message=AES (K, pay)); signing a code using sk_{ECC} (code=ECC (sk_{ECC}, message)); distributing pk_{ECC} (publicly, or at least to POS); and distributing the code (to at least PoS). The protocol can further include any of the following (typically performed by PoS): reading the code; verifying the signature with pk_{ECC} (e.g., using a check signature (code, pk_{ECC}) function), and rejecting the message if the check fails; decrypting the payment using K_{AES}; and processing the payment.

Similar to the implementation of the adjudication module 108 in general, the protocol 122 can be implemented in a variety of environments, such as locally, through cloud computing, or in a decentralized manner. Thus, in some cases, one or more portions of the protocol is carried out via API. Although some basic functionality of suitable API implementations is discussed above, more specific examples relating to API implementations (sometimes referred to as the SKUPay API or the SKU API) are included below for illustrative purposes. These examples help show some of the advantages of presently available API implementations over non-API implementations and over other systems that utilize APIs.

In some embodiments, when initializing and defining customer events, adjudication module API endpoints support a multi-schema approach. Each request may include a “type” representing the object type and related schema. Requests of a certain “type” parameter will generate a response of the same type of a 1-1 basis. A purpose of this multi-schema architecture is to protect and future-proof implementations of the system 100 (or portions thereof, such as the adjudication module 108). In this manner, future versions of the system 100 will maintain the same implemented endpoint list, and addition types and schemas may be added seamlessly. For example: POST/transaction/{tx_id}/payment of “type” CARD will respond with a CARD schema and object; and POST/transaction/{tx_id}/payment of “type” SkupayCode will respond with a SKUpayCode schema and object.

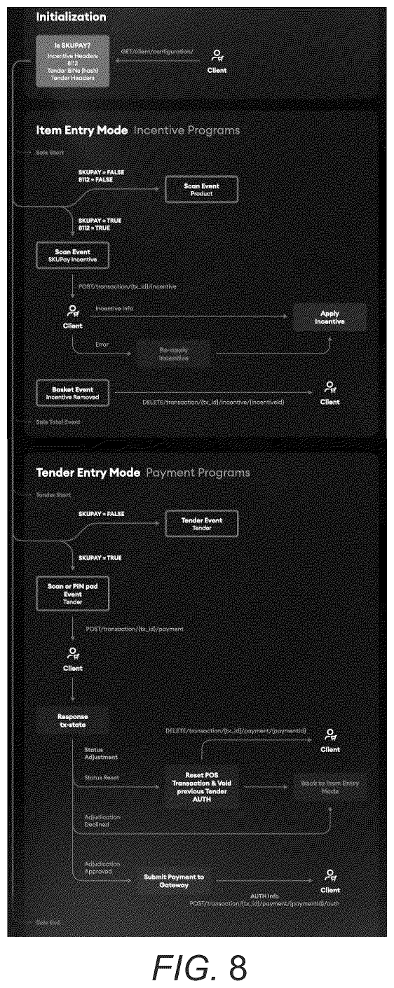

FIG. 8 illustrates some aspects of API initialization and item entry. Regarding initialization, the API can implement a GET/client/configuration endpoint. When initializing the retail system (e.g., the POS system or device), this endpoint can provide all necessary SKUpay program (e.g., any program described herein) BINs and scannable header codes, for both incentive and payment program types. These codes are to be referenced respectively by each item-scan-event or tender-event in order to determine when the event requires an interaction with the SKUpay API or not. Usage is typically when initiating the retail system (e.g., the POS) at startup.

Further, the API can implement a POST/transaction/endpoint. This endpoint can allow SKUPay (e.g., the system 100, or more specifically, the adjudication module 108, as accessed via API) to uniquely identify transactions using a UUID-V4 format. This endpoint can be used to generate a UUID before calling POST/transaction/{tx_id}/incentive or POST/transaction/{tx_id}/payment. In some embodiments, this endpoint is optional, but it may be especially useful for those environments that cannot easily generate a UUID-V4. That said, in some cases, it is possible to separately generate a UUID-V4 and call POST/transaction/{tx_id}/incentive or POST/transaction/{tx_id}/payment thereafter to initiate a transaction. Usage is typically prior to initiating a transaction, either as an incentive or a payment.

Regarding item entry mode, additional API endpoints may be useful. For example, POST/transaction/{tx_id}/incentive can be called when any of the GET/client/configuration incentive-headers match the header of the item being scanned. The AddIncentiveToTransactionResponse object can include an array of the scanned incentive's associated items, and related discounted amounts that should be added (as a negative amount) to the shopping-basket, assuming an item is matched within the shopping-basket. This usually occurs when the retail system (e.g., the POS) scans a barcode or QR-code, and the header is either SKUX or 8112. In this regard, the “tx_id” should utilize a UUID-V4 (as discussed above) to maintain a universal format across all SKUPay (e.g., system 100) implementations. The tx_id, in some cases, controls for idempotency for subsequent calls to the SKUPay API. Usage is typically when an item/barcode/QR-code is being scanned whose header matches that of a SKUPay program.

Another endpoint is DELETE/transaction/{tx_is}/incentive/{incentive_id}, which should be called for any existing incentive or its related items that have been removed from the shopping-basket. Again, usage is typically when an incentive item or barcode or QR-code (or other code) that was previously initiated via POST/transaction {tx_id}/incentive has been removed from the shopping-basket.

Regarding tender entry mode (where payment programs are initiated), POST/transaction {tx_id}/payment is an endpoint that should be called when any of the GET/client/configuration satisfy either of the following: (a) Tender-BINs match the BIN being dipped, tapped, or swiped in the pinpad; or (b) Tender-headers match the header of a QR-code being scanned. This endpoint should be called before sending the payment-authorization-request to the payment-gateway, as the output of this endpoint's response will be needed (AddPaymentToTransactionResponse) in order to generate the payment-authorization-request (in particular, the Amount value).

When the payment is initialized via Method=CARD {Pinpad: dip, tap, swipe} the pinpad's encrypted card details should be used for the tender, in conjunction with the response Amount value. Additionally, request parameters panFirst6 and panLast4 should be found as free-text from the pinpad object. Also, For: {Swipe} cardholderName and expirationDate should be found as part of the track2 information on the card's magnetic stripe. In contrast, when the payment is initialized via Method=SkupayCode {Scanner: Scan} then the AddPaymentToTransactionResponse: method: SkupayCode object will respond with both: (a) Amount value; and (b) a non-PCI payment object that is to be sent to the Payment Gateway for tender (e.g., a giftcard object).

It is generally expected that when a SKUPay Payment event is enacted, it will represent either a split-tender and/or a partial authorization transaction-type. In some cases, SKUPay Payment programs will only pay for a portion of the total-amount, due to the adjudicated items coupled with the Program's Protocol-enum. Therefore, it is also possible to have multiple SKUPay Payment programs tendered within the same transaction. Whatever remains of the total amount not paid for by the SKUPay Payment program should be paid with the customer's personal funds. In short, this endpoint should generally be used when a tender is being scanned whose payment-header matches that of a SKUPay Program. The response will include the payment-info. It should also be used when a tender is being dipped, tapped, or swiped, whose BIN matches that of a SKUPay Program. The payment info from the dip, tap, or swipe, can then be used. In each case, this usage is typically accomplished before the tender-info is sent to the payment gateway.

Another endpoint is POST/transaction/{tx_id}/payment/{payment_id}/auth. In this regard, in some embodiments, for each and every POST/transaction/{tx_id}/payment there should be a corresponding POST/transaction {tx_id}/payment/{payment_id}/auth using the same [tx_id & payment_id} parameters, whenever the transaction-authorization-response is received from the payment-gateway/processor; regardless of when it's approved or declined. As a note, some embodiments of the SKUPay API do not recognize the switch from Item-Entry-Mode to Tender-Entry-Mode until after the first approved authorized payment. Once the first approved POST/transaction {tx_id}/payment/{payment_id}/auth is made, according to some embodiments, the SKUPay API may no longer accept any other incentives (via POST/transaction {tx_id}/incentive, and they may thereafter be rejected). Usage is typically where a tender that was previously requested to the payment gateway is being returned with authorization info; either as approved or declined.

Another endpoint is DELETE/transaction/{tx_id}/payment/{payment_id}. This endpoint should generally be called when any of the already adjudicated items related to POST/transaction {tx_id}/incentive or POST/transaction {tx_id}/payment have been removed from the shopping-basket after Tender-Entry-Mode has been recognized by the SKUPay API (i.e., only after first approved authorized payment has been made and then the shopping-basket items changed). When this endpoint is called, and the payment {payment_id} is deleted, the transaction is effectively voided. In some cases, since the approved payment/tender was already made as an association to an adjudicated item, in some cases to the adjudication process is automatically started anew to further mitigate the possibility of customer fraud (e.g., where the customer removes an item that was already paid for by the program to take advantage of the free credit toward remaining items not yet purchased. Usage is typically where a tender, either as a split-tender or as a partial-authorization (or both) was previously approved, and where the customer is now adding or removing items to or from the shopping basket.

Again, the examples of endpoints provided above are for illustrative purposes, and the API (in some embodiments) may include other endpoints or implement the systems and methods described herein through other technological mechanisms.

The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

What is claimed and desired to be secured by Letters Patent is:

1. An adjudication module for omni-channel item-level promotional offer adjudication, the adjudication module comprising at least one of:
an integrated container comprising application code; and
an API,
wherein the adjudication module is configured to interface with a retail system comprising a payment module and at least one of:
a POS system; and
a cloud-computing system,
wherein the adjudication module is configured to:
receive and store item-level information relating to one or more inventory items for which use of a one-time-use coupon code is authorized;
receive a purchase request comprising a payment amount and information concerning an item for purchase; and
receive the one-time-use coupon code;
wherein if the information concerning the item for purchase matches the item-level information for which use of the one-time-use coupon code is authorized, the adjudication module applies the one-time-use coupon code to the purchase request to apply a discount to the payment amount, but if the information concerning the item for purchase does not match the item-level information for which use of the one-time-use coupon code is authorized, the adjudication module does not apply the one-time-use coupon code to the purchase request,
wherein the adjudication module enables the retail system to access a distributed ledger.

2. The adjudication module of claim 1, wherein the item level information comprises an identifier selected from the group consisting of a stock keeping unit (SKU), a global trade item number (GTIN), a universal product code (UPC), an international article number (ARN), an Australian product number (APN), or a price look-up code (PLU).

3. The adjudication module of claim 1, wherein the retail system is configured to establish a retailer communicative connection with a bank card processor system, and wherein the adjudication module is configured to operate without error even if the retailer communicative connection is disrupted.

4. The adjudication module of claim 1, wherein the adjudication module is configured to operate on the POS system without error whether or not the POS system has internet connectivity.

5. The adjudication module of claim 1, wherein the container further comprises a runtime library, a system library, and a settings configuration.

6. The adjudication module of claim 1, wherein the adjudication module is configured to utilize a memory storage of the retail system to cause the retail system to operate as a node for a distributed ledger, wherein the distributed ledger is a decentralized distributed ledger comprising a plurality of nodes.

7. The adjudication module of claim 6, wherein the distributed ledger comprises an immutable or selectively mutable transaction log, and wherein the transaction log comprises a list of coupon codes comprising the one-time-use coupon code, and wherein each coupon code in the list of coupon codes is accompanied by an indication of whether or not such coupon code has been redeemed, and wherein when the adjudication module applies the one-time-use coupon code to a purchase request, the retail system updates the transaction log to indicate that the one-time-use coupon code has been redeemed.

8. The adjudication module of claim 7, wherein prior to applying the one-time-use coupon code to a purchase request, the adjudication module reads the transaction log of the distributed ledger to determine whether the one-time-use coupon code has already been redeemed, and wherein if the coupon code has already been redeemed, the adjudication module does not apply the one-time-use coupon code to the purchase request.

9. The adjudication module of claim 6, wherein the distributed ledger comprises a blockchain.

10. The adjudication module of claim 6, wherein the distributed ledger comprises a plurality of nodes and a consensus algorithm configured to ensure that the distributed ledger is identical across the plurality of nodes.

11. The adjudication module of claim 6, wherein the adjudication module is configured to issue additional coupon codes.

12. A system for omni-channel item-level promotional offer adjudication, the system comprising:
a distributed ledger comprising:
a plurality of nodes;
a transaction log comprising a list of coupon codes and an indication of whether each of the coupon codes has already been redeemed; and
a consensus algorithm configured to synchronize the transaction log to ensure that all copies of the transaction log are identical across the plurality of nodes;
a first retail system comprising a first payment module and at least one of:
a first POS system; and
a first cloud-computing system;
a second retail system comprising a second payment module and at least one of:
a second POS system; and
a second cloud-computing system; and
an adjudication module that enables each of the first retail system and the second retail system to access the distributed ledger, the adjudication module comprising at least one of:
an integrated container comprising application code; and
an API configured to allow the retail system to interface with the adjudication module,
wherein the adjudication module interfaces with each of the first retail system and the second retail system, and wherein the adjudication module is configured to:
receive and store item-level information relating to one or more inventory items for which use of a one-time-use coupon code is authorized;
receive a purchase request comprising a payment amount and information concerning an item for purchase;
receive a one-time-use coupon code; and
read the transaction log of the distributed ledger to check whether the one-time-use coupon code has already been redeemed,
wherein if the one-time-use coupon code has not already been redeemed, and if the information concerning the item for purchase matches the item-level information for which use of the one-time-use coupon code is authorized, the adjudication module applies the one-time-use coupon code to the purchase request to apply a discount to the payment amount, but if the one-time-use coupon code has already been redeemed, or if the information concerning the item for purchase does not match the item-level information for which use of the one-time-use coupon code is authorized, the adjudication module does not apply the one-time-use coupon code to the purchase request.

13. The system of claim 12, wherein the first retail system comprises the first POS system, and wherein the second retail system comprises the second POS system.

14. The system of claim 12, wherein the first retail system comprises the first POS system, and wherein the second retail system comprises the second cloud-computing system.

15. The system of claim 12, wherein the distributed ledger is a public permissionless ledger.

16. The system of claim 12, wherein the plurality of nodes comprises the first retail system and the second retail system.

17. The system of claim 12, wherein each of the first retail system and the second retail system is configured to establish a retailer communicative connection with a bank card processor system, and wherein the adjudication module is configured to operate without error even if the retailer communicative connection is disrupted.

18. The system of claim 12, wherein the item-level information comprises a first set of item-level information from a first source and a second set of item-level information from a second source.

19. The system of claim 12, wherein the system is configured to read, and deliver to the adjudication module, information obtained from a manual entry, information obtained from a scanning of a QR code, and information obtained from reading a card.

20. A system for omni-channel item-level promotional offer adjudication, the system comprising:
a distributed ledger comprising:
a plurality of nodes;
a transaction log; and
a consensus algorithm configured to synchronize the transaction log across the plurality of nodes;
a retail system comprising a payment module; and
an adjudication module that enables the retail system to access the distributed ledger,
wherein the adjudication module is configured to execute a security protocol comprising:
generating a K_{AES};
generating an asymmetric key pair comprising a sk_{ECC} and a pk_{ECC};
encrypting a payment using the K_{AES};
signing a code using the sk_{ECC};
distributing the pk_{ECC} to the retail system; and
distributing the code to the retail system.
